(19) United States
(12) Patent Application Publication
(10) Pub. No.: US 2004/0160524 A1
(43) Pub. Date: Aug. 19, 2004

(54) Utilising exposure information for image processing in a digital image camera

(76) Inventor: Kia Silverbrook, Balmain (AU)

Correspondence Address: SILVERBROOK RESEARCH PTY LTD, 393 DARLING STREET, BALMAIN, 2041, AU

(21) Appl. No.: 10/780,625

(22) Filed: Feb. 19, 2004

Related U.S. Application Data
(63) Continuation-in-part of application No. 09/112,743, filed on Jul. 10, 1998, now Pat. No. 6,727,951.

(30) Foreign Application Priority Data
Jul. 15, 1997 (AU) PO7999
Jul. 15, 1997 (AU) PO7991

(51) Int. Cl. H04N 5/238

(52) U.S. Cl. 348/363

(57) ABSTRACT

A method of processing an image taken with a digital camera including an auto exposure setting, the method comprising the step of utilising the information to process a sensed image, utilising step comprises utilising the auto exposure setting to determine an advantageous re-mapping of colours within the image so as to produce an amended image such as adding exposure specific graphics to said image.

This is a Continuation-in-Part of Ser. No. 09/112,743 filed Jul. 10, 1998

### FIELD OF THE INVENTION

The present invention relates to an image processing method and apparatus and, in particular, discloses a process for Utilising Exposure Information in a Digital Image Camera.

The present invention further relates to the field of digital image processing and in particular, the field of processing of images taken via a digital camera.

### BACKGROUND OF THE INVENTION

Recently, digital cameras have become increasingly popular. These cameras normally operate by means of imaging a desired image utilising a charge coupled device (CCD) array and storing the imaged scene on an electronic storage medium for later down loading onto a computer system for subsequent manipulation and printing out. Normally, when utilising a computer system to print out an image, sophisticated software may available to manipulate the image in accordance with requirements.

Unfortunately such systems require significant post processing of a captured image and normally present the image in an orientation to which is was taken, relying on the post processing process to perform any necessary or required modifications of the captured image. Further, much of the environmental information available when the picture was taken is lost.

### SUMMARY OF THE INVENTION

It is an object of the present invention to provide for the utilisation of exposure information in an image specific manner.

In accordance with a first aspect of the invention there is provided a method of processing a sensed image taken with a digital camera, including an auto exposure setting means, said method comprising the step of utilising the auto exposure setting from said auto exposure setting means to process said sensed image to add exposure specific graphics to said image.

The utilising step can comprise utilising the auto exposure setting to determine an advantageous re-mapping of colours within the image so as to produce an amended image having colours within an image transformed to account of the auto exposure setting. The processing can comprise re-mapping image colours so they appear deeper and richer when the exposure setting indicates low light conditions and re-mapping image colours to be brighter and more saturated when the auto exposure setting indicates bright light conditions.

### BRIEF DESCRIPTION OF DRAWINGS

Notwithstanding any other forms which may fall within the scope of the present invention, preferred forms of the invention will now be described, by way of example only, with reference to the accompanying drawings which:

FIG. 1 illustrates the method of operation of the preferred embodiment;

FIG. 2 illustrates a form of print roll ready for purchase by a consumer;

FIG. 3 illustrates a perspective view, partly in section, of an alternative form of a print roll;

FIG. 4 is a left side exploded perspective view of the print roll of FIG. 3; and,

FIG. 5 is a right side exploded perspective view of a single print roll.

### DESCRIPTION OF PREFERRED AND OTHER EMBODIMENTS

The preferred embodiment is preferable implemented through suitable programming of a hand held camera device such as that described in the concurrently filed application entitled “A Digital Image Printing Camera with Image Processing Capability” filed concurrently herewith by the present applicant the content of which is hereby specifically incorporated by cross reference and the details of which, and other related applications are set out in the tables below.

The aforementioned patent specification discloses a camera system, hereinafter known as an “Artcam” type camera, wherein sensed images can be directly printed out by an Artcam portable camera unit. Further, the aforementioned specification discloses means and methods for performing various manipulations on images captured by the camera sensing device leading to the production of various effects in any output image. The manipulations are disclosed to be highly flexible in nature and can be implemented through the insertion into the Artcam of cards having encoded thereon various instructions for the manipulation of images, the cards hereinafter being known as Artcards. The Artcam further has significant onboard processing power by an Artcam Central Processor unit (ACP) which is interconnected to a memory device for the storage of important data and images.

In the preferred embodiment, the Artcam has an auto exposure sensor for determining the light level associated with the captured image. This auto exposure sensor is utilised to process the image in accordance with the set light value so as to enhance portions of the image.

Preferably, the area image sensor includes a means for determining the light conditions when capturing an image. The area image sensor adjusts the dynamic range of values captured by the CCD in accordance with the detected level sensor. The captured image is transferred to the Artcam central processor and stored in the memory store. Intensity information, as determined by the area image sensor, is also forwarded top the ACP. This information is utilised by the Artcam central processor to manipulate the stored image to enhance certain effects.

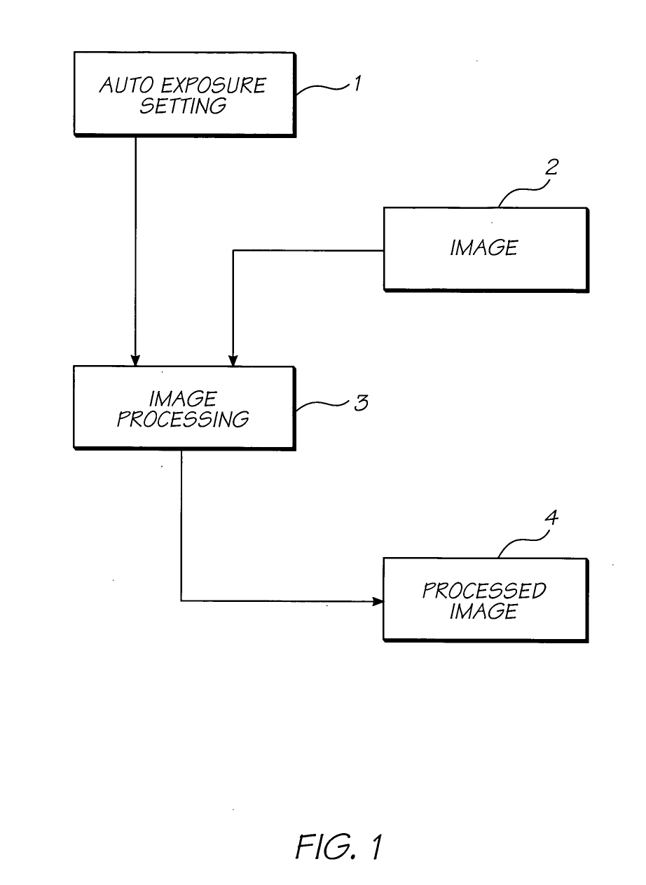

Turning now to FIG. 1, the auto exposure setting information 1 is utilised in conjunction with the stored image 2 to process the image by utilising the ACP. The processed image is returned to the memory store for later printing out 4 on the output printer.

A number of processing steps can be undertaken in accordance with the determined light conditions. Where the auto exposure setting 1 indicates that the image was taken in a low light condition, the image pixel colours are selectively re-mapped so as to make the image colours stronger, deeper and richer.

Where the auto exposure information indicates that highlight conditions were present when the image was taken, the image colours can be processed to make them brighter and more saturated. The re-colouring of the image can be undertaken by conversion of the image to a hue-saturation-value (HSV) format and an alteration of pixel values in accordance with requirements. The pixel values can then be output converted to the required output colour format of printing.

Of course, many different re-colouring techniques may be utilised. Preferably, the techniques are clearly illustrated on the pre-requisite Artcard inserted into the reader. Alternatively, the image processing algorithms can be automatically applied and hard-wired into the camera for utilization in certain conditions.

Alternatively, the Artcard inserted could have a number of manipulations applied to the image which are specific to the auto-exposure setting. For example, clip arts containing candles etc could be inserted in a dark image and large suns inserted in bright images.

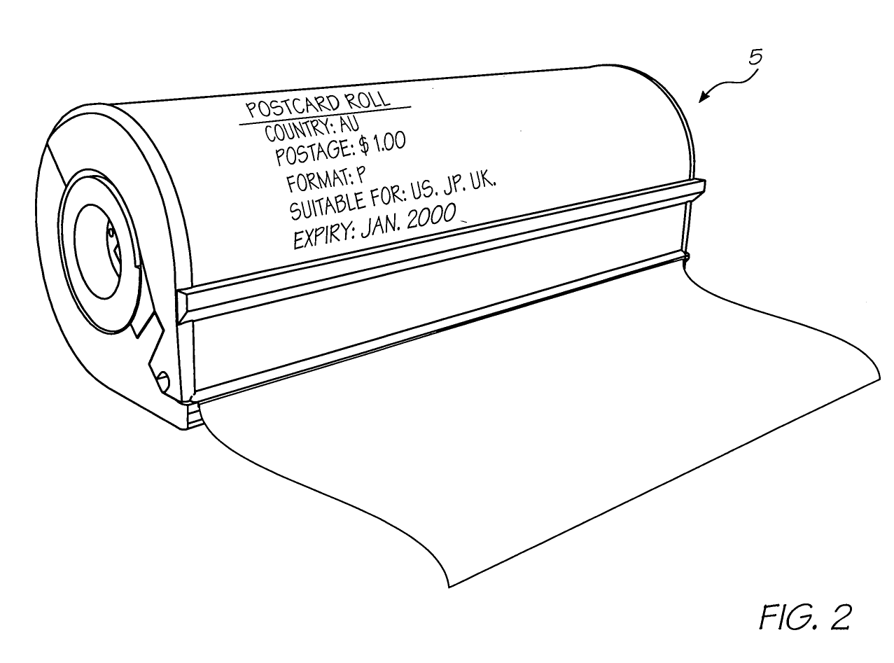

Referring now to FIGS. 2 to 5, the Artcam prints the images onto media stored in a replaceable print roll 5. In some preferred embodiments, the operation of the camera device is such that when a series of images is printed on a first surface of the print roll, the corresponding backing surface has a ready made postcard which can be immediately dispatched at the nearest post office box within the jurisdiction. In this way, personalized postcards can be created.

It would be evident that when utilising the postcard system as illustrated FIG. 2 only predetermined image sizes are possible as the synchronization between the backing postcard portion and the front image must be maintained. This can be achieved by utilising the memory portions of the authentication chip stored within the print roll 5 to store details of the length of each postcard backing format sheet. This can be achieved by either having each postcard the same size or by storing each size within the print rolls on-board print chip memory.

In an alternative embodiment, there is provided a modified form of print roll which can be constructed mostly from injection moulded plastic pieces suitably snapped fitted together. The modified form of print roll has a high ink storage capacity in addition to a somewhat simplified construction. The print media onto which the image is to be printed is wrapped around a plastic sleeve former for simplified construction. The ink media reservoir has a series of air vents which are constructed so as to minimise the opportunities for the ink flow out of the air vents. Further, a rubber seal is provided for the ink outlet holes with the rubber seal being pierced on insertion of the print roll into a camera system. Further, the print roll includes a print media ejection slot and the ejection slot includes a surrounding moulded surface which provides and assists in the accurate positioning of the print media ejection slot relative to the printhead within the printing or camera system.

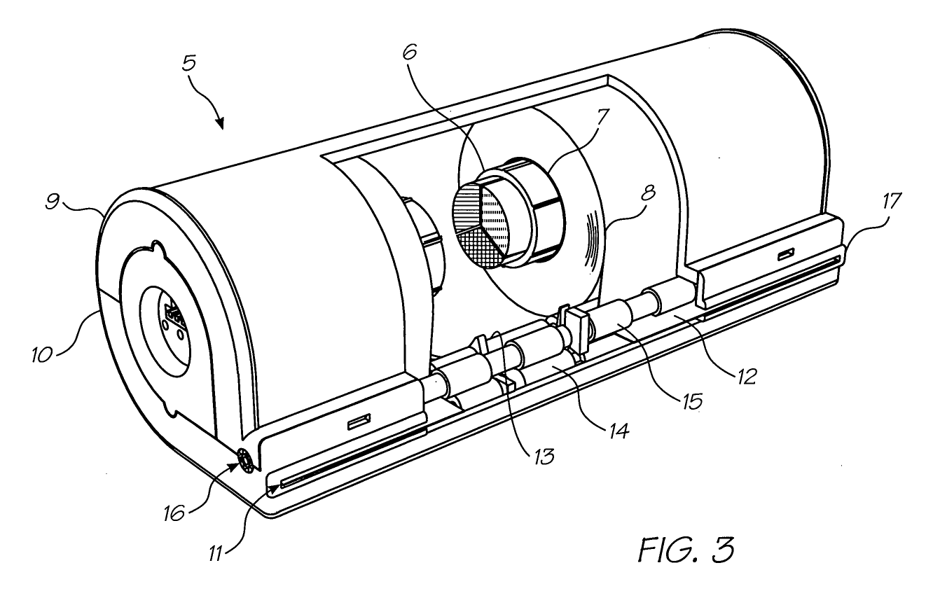

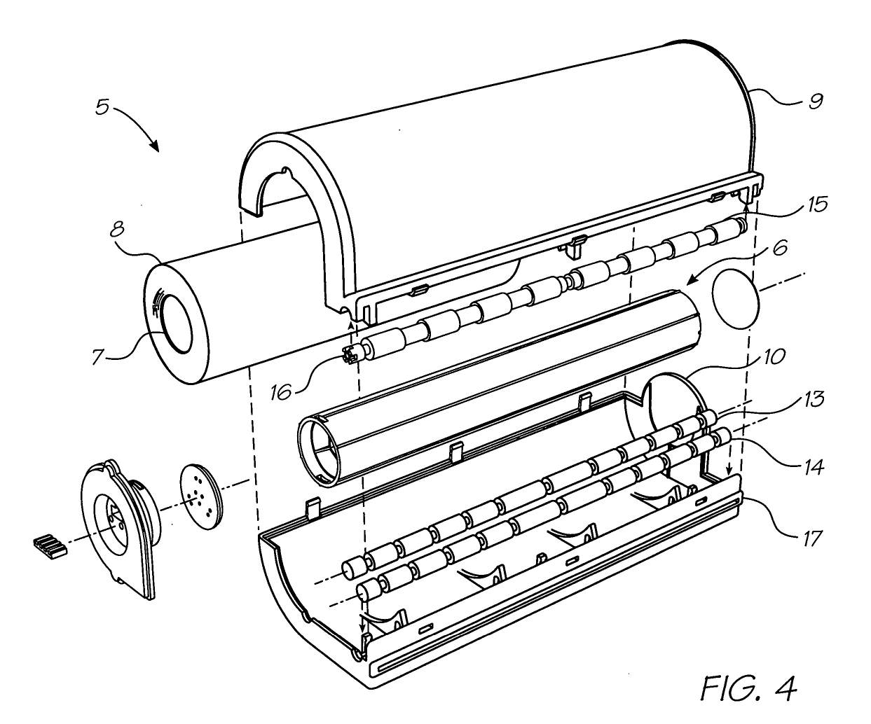

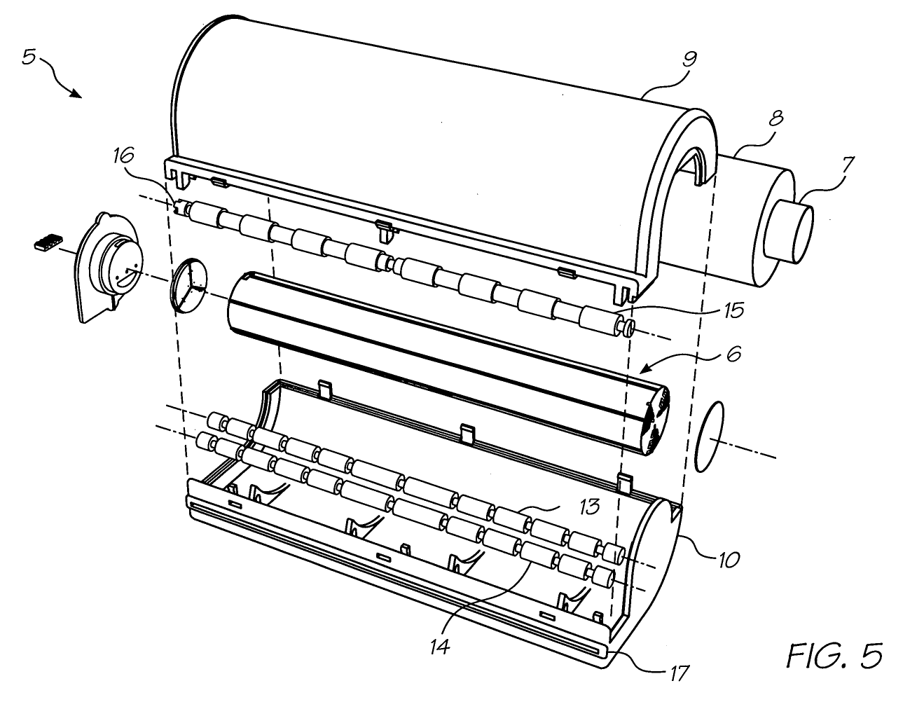

Turning to FIG. 3 there is illustrated a single point roll unit 5 in an assembled form with a partial cutaway showing internal portions of the print roll. FIG. 4 and FIG. 5 illustrate left and right side exploded perspective views respectively. The print roll 5 is constructed around the internal core portion 6 which contains an internal ink supply. Outside of the core portion 6 is provided a former 7 around which is wrapped a paper or film supply 8. Around the paper supply it is constructed two cover pieces 9, 10 which snap together around the print roll so as to form a covering unit as illustrated in FIG. 3. The bottom cover piece 10 includes a slot 11 through which the output of the print media 12 for interconnection with the camera system.

Two pinch rollers 13, 14 are provided to pinch the paper against a drive pinch roller 15 so they together provide for a decurling of the paper around the roller 15. The decurling acts to negate the strong curl that may be imparted to the paper from being stored in the form of print roll for an extended period of time. The rollers 13, 14 are provided to form a snap fit with end portions of the cover base portion 10 and the roller 15 which includes a cogged end 16 for driving, snap fits into the upper cover piece 9 so as to pinch the paper 12 firmly between.

The cover pieces 9, 10 includes an end protuberance or lip 17. The end lip 17 is provided for accurately alignment of the exit hole of the paper with a corresponding printing heat platen structure within the camera system. In this way, accurate alignment or positioning of the exiting paper relative to an adjacent printhead is provided for full guidance of the paper to the printhead.

It would be appreciated by a person skilled in the art that numerous variations and/or modifications may be made to the present invention as shown in the specific embodiment without departing from the spirit or scope of the invention as broadly described. The present embodiment is, therefore, to be considered in all respects to be illustrative and not restrictive.

The present invention is best utilized in the Artcam device, the details of which are set out in the following paragraphs.

### Ink Jet Technologies

The embodiments of the invention use an ink jet printer type device. Of course many different devices could be used. However presently popular ink jet printing technologies are unlikely to be suitable.

The most significant problem with thermal inkjet is power consumption. This is approximately 100 times that required for high speed, and stems from the energy-inefficient means of drop ejection. This involves the rapid boiling of water to produce a vapor bubble which expels the ink. Water has a very high heat capacity, and must be superheated in thermal inkjet applications. This leads to an efficiency of around 0.02%, from electricity input to drop momentum (and increased surface area) out.

The most significant problem with piezoelectric inkjet is size and cost. Piezoelectric crystals have a very small deflection at reasonable drive voltages, and therefore require a large area for each nozzle. Also, each piezoelectric actuator must be connected to its drive circuit on a separate substrate. This is not a significant problem at the current limit of around 300 nozzles per print head, but is a major impediment to the fabrication of pagewide print heads with 19,200 nozzles.

Ideally, the inkjet technologies used meet the stringent requirements of in-camera digital color printing and other high quality, high speed, low cost printing applications. To meet the requirements of digital photography, new inkjet technologies have been created. The target features include:

low power (less than 10 Watts)

high resolution capability (1,600 dpi or more)

photographic quality output

low manufacturing cost

small size (pagewidth times minimum cross section) high speed (<2 seconds per page).

All of these features can be met or exceeded by the inkjet systems described below with differing levels of difficulty. 45 different inkjet technologies have been developed by the Assignee to give a wide range of choices for high volume manufacture. These technologies form part of separate applications assigned to the present Assignee as set out in the table below.

The inkjet designs shown here are suitable for a wide range of digital printing systems, from battery powered one-time use digital cameras, through to desktop and network printers, and through to commercial printing systems

For ease of manufacture using standard process equipment, the print head is designed to be a monolithic 0.5 micron CMOS chip with MEMS post processing. For color photographic applications, the print head is 100 mm long, with a width which depends upon the inkjet type. The smallest print head designed is IJ38, which is 0.35 mm wide, giving a chip area of 35 square mm. The print heads each contain 19,200 nozzles plus data and control circuitry.

Ink is supplied to the back of the print head by injection molded plastic ink channels. The molding requires 50 micron features, which can be created using a lithographically micromachined insert in a standard injection molding tool. Ink flows through holes etched through the wafer to the nozzle chambers fabricated on the front surface of the wafer. The print head is connected to the camera circuitry by tape automated bonding.

### Cross-Referenced Applications

The following table is a guide to cross-referenced patent applications filed concurrently herewith and discussed hereinafter with the reference being utilized in subsequent tables when referring to a particular case:

| Docket | Refer- | |
|---|---|---|
| No. | ence | Title |
| IJ01US | IJ01 | Radiant Plunger Ink Jet Printer |
| IJ02US | IJ02 | Electrostatic Ink Jet Printer |
| IJ03US | IJ03 | Planar Thermoelastic Bend Actuator Ink Jet |
| IJ04US | IJ04 | Stacked Electrostatic Ink Jet Printer |
| IJ05US | IJ05 | Reverse Spring Lever Ink Jet Printer |
| IJ06US | IJ06 | Paddle Type Ink Jet Printer |
| IJ07US | IJ07 | Permanent Magnet Electromagnetic Ink Jet Printer |
| IJ08US | IJ08 | Planar Swing Grill Electromagnetic Ink Jet Printer |
| IJ09US | IJ09 | Pump Action Refill Ink Jet Printer |
| IJ10US | IJ10 | Pulsed Magnetic Field Ink Jet Printer |
| IJ11US | IJ11 | Two Plate Reverse Firing Electromagnetic Ink Jet |
| | | Printer |
| IJ12US | IJ12 | Linear Stepper Actuator Ink Jet Printer |
| IJ13US | IJ13 | Gear Driven Shutter Ink Jet Printer |
| IJ14US | IJ14 | Tapered Magnetic Pole Electromagnetic Ink |
| | | Jet Printer |
| IJ15US | IJ15 | Linear Spring Electromagnetic Grill Ink Jet Printer |
| IJ16US | IJ16 | Lorenz Diaphragm Electromagnetic Ink Jet Printer |
| IJ17US | IJ17 | PTFE Surface Shooting Shuttered Oscillating |
| | | Pressure Ink Jet Printer |
| IJ18US | IJ18 | Buckle Grip Oscillating Pressure Ink Jet Printer |
| IJ19US | IJ19 | Shutter Based Ink Jet Printer |
| IJ20US | IJ20 | Curling Calyx Thermoelastic Ink Jet Printer |
| IJ21US | IJ21 | Thermal Actuated Ink Jet Printer |
| IJ22US | IJ22 | Iris Motion Ink Jet Printer |
| IJ23US | IJ23 | Direct Firing Thermal Bend Actuator Ink Jet Printer |
| IJ24US | IJ24 | Conductive PTFE Ben Activator Vented Ink |
| | | Jet Printer |
| IJ25US | IJ25 | Magnetostrictive Ink Jet Printer |
| IJ26US | IJ26 | Shape Memory Alloy Ink Jet Printer |
| IJ27US | IJ27 | Buckle Plate Ink Jet Printer |
| IJ28US | IJ28 | Thermal Elastic Rotary Impeller Ink Jet Printer |
| IJ29US | IJ29 | Thermoelastic Bend Actuator Ink Jet Printer |
| IJ30US | IJ30 | Thermoelastic Bend Actuator Using PTFE and |
| | | Corrugated Copper Ink Jet Printer |
| IJ31US | IJ31 | Bend Actuator Direct Ink Supply Ink Jet Printer |
| IJ32US | IJ32 | A High Young's Modulus Thermoelastic |
| | | Ink Jet Printer |
| IJ33US | IJ33 | Thermally actuated slotted chamber wall ink jet printer |
| IJ34US | IJ34 | Ink Jet Printer having a thermal actuator comprising an |
| | | external coiled spring |
| IJ35US | IJ35 | Trough Container Ink Jet Printer |
| IJ36US | IJ36 | Dual Chamber Single Vertical Actuator Ink Jet |
| IJ37US | IJ37 | Dual Nozzle Single Horizontal Fulcrum |
| | | Actuator Ink Jet |
| IJ38US | IJ38 | Dual Nozzle Single Horizontal Actuator Ink Jet |
| IJ39US | IJ39 | A single bend actuator cupped paddle ink jet printing |
| | | device |
| IJ40US | IJ40 | A thermally actuated ink jet printer having a series of |
| | | thermal actuator units |
| IJ41US | IJ41 | A thermally actuated ink jet printer including a |
| | | tapered heater element |
| IJ42US | IJ42 | Radial Back-Curling Thermoelastic Ink Jet |
| IJ43US | IJ43 | Inverted Radial Back-Curling Thermoelastic Ink Jet |
| IJ44US | IJ44 | Surface bend actuator vented ink supply ink jet printer |
| IJ45US | IJ45 | Coil Acutuated Magnetic Plate Ink Jet Printer |

### Tables of Drop-on-Demand Inkjets

Eleven important characteristics of the fundamental operation of individual inkjet nozzles have been identified. These characteristics are largely orthogonal, and so can be elucidated as an eleven dimensional matrix. Most of the eleven axes of this matrix include entries developed by the present assignee.

The following tables form the axes of an eleven dimensional table of inkjet types.

Actuator mechanism (18 types)

Basic operation mode (7 types)

Auxiliary mechanism (8 types)

Actuator amplification or modification method (17 types)

Actuator motion (19 types)

Nozzle refill method (4 types)

Method of restricting back-flow through inlet (10 types)

Nozzle clearing method (9 types)

Nozzle plate construction (9 types)

Drop ejection direction (5 types)

Ink type (7 types)

The complete eleven dimensional table represented by these axes contains 36.9 billion possible configurations of inkjet nozzle. While not all of the possible combinations result in a viable inkjet technology, many million configurations are viable. It is clearly impractical to elucidate all of the possible configurations. Instead, certain inkjet types have been investigated in detail. These are designated IJ01 to IJ45 above.

Other inkjet configurations can readily be derived from these 45 examples by substituting alternative configurations along one or more of the 11 axes. Most of the IJ01 to IJ45 examples can be made into inkjet print heads with characteristics superior to any currently available inkjet technology.

Where there are prior art examples known to the inventor, one or more of these examples are listed in the examples column of the tables below. The IJ01 to IJ45 series are also listed in the examples column. In some cases, a printer may be listed more than once in a table, where it shares characteristics with more than one entry.

Suitable applications include: Home printers, Office network printers, Short run digital printers, Commercial print systems, Fabric printers, Pocket printers, Internet WWW printers, Video printers, Medical imaging, Wide format printers, Notebook PC printers, Fax machines, Industrial printing systems, Photocopiers, Photographic minilabs etc.

The information associated with the aforementioned 11 dimensional matrix are set out in the following tables.

ACTUATOR MECHANISM (APPLIED ONLY TO SELECTED INK DROPS)

| Actuator | | | | |
|---|---|---|---|---|
| Mechanism | Description | Advantages | Disadvantages | Examples |
| Thermal | An electrothermal | Large force | High power | Canon Bubblejet |
| bubble | heater heats the ink to | generated | Ink carrier limited to | 1979 Endo et al GB |
| | above boiling point, | Simple construction | water | patent 2,007,162 |
| | transferring significant | No moving parts | Low efficiency | Xerox heater-in-pit |
| | heat to the aqueous | Fast operation | High temperatures | 1990 Hawkins et al |
| | ink. A bubble | Small chip area | required | USP 4,899,181 |
| | nucleates and quickly | required for actuator | High mechanical | Hewlett-Packard TIJ |
| | forms, expelling the | | stress | 1982 Vaught et al |
| | ink. | | Unusual materials | USP 4,490,728 |
| | The efficiency of the | | required | |
| | process is low, with | | Large drive | |
| | typically less than | | transistors | |
| | 0.05% of the electrical | | Cavitation causes | |
| | energy being | | actuator failure | |
| | transformed into | | Kogation reduces | |
| | kinetic energy of the | | bubble formation | |
| | drop. | | Large print heads | |
| | | | are difficult to | |
| | | | fabricate | |
| Piezoelectric | A piezoelectric crystal | Low power | Very large area | Kyser et al USP |
| | such as lead | consumption | required for actuator | 3,946,398 |
| | lanthanum zirconate | Many ink types can | Difficult to integrate | Zoltan USP |
| | (PZT) is electrically | be used | with electronics | 3,683,212 |
| | activated, and either | Fast operation | High voltage drive | 1973 Stemme USP |
| | expands, shears, or | High efficiency | transistors required | 3,747,120 |
| | bends to apply | | Full pagewidth print | Epson Stylus |
| | pressure to the ink, | | heads impractical | Tektronix |
| | ejecting drops. | | due to actuator size | IJ04 |
| | | | Requires electrical | |
| | | | poling in high field | |
| | | | strengths during | |
| | | | manufacture | |
| Electrostrictive | An electric field is | Low power | Low maximum | Seiko Epson, Usui |
| | used to activate | consumption | strain (approx. | et all JP 253401/96 |
| | electrostriction in | Many ink types can | 0.01%) | IJ04 |
| | relaxor materials such | be used | Large area required | |
| | as lead lanthanum | Low thermal | for actuator due to | |
| | zirconate titanate | expansion | low strain | |
| | (PLZT) or lead | Electric field | Response speed is | |
| | magnesium niobate | strength required | marginal (˜10 μs) | |
| | (PMN). | (approx. 3.5 V/μm) | High voltage drive | |
| | | can be generated | transistors required | |
| | | without difficulty | Full pagewidth print | |
| | | Does not require | heads impractical | |
| | | electrical poling | due to actuator size | |
| Ferroelectric | An electric field is | Low power | Difficult to integrate | IJ04 |
| | used to induce a phase | consumption | with electronics | |
| | transition between the | Many ink types can | Unusual materials | |
| | antiferroelectric (AFE) | be used | such as PLZSnT are | |
| | and ferroelectric (FE) | Fast operation (<1 μs) | required | |
| | phase. Perovskite | Relatively high | Actuators require a | |
| | materials such as tin | longitudinal strain | large area | |
| | modified lead | High efficiency | | |
| | lanthanum zirconate | Electric field | | |
| | titanate (PLZSnT) | strength of around 3 | | |
| | exhibit large strains of | V/μm can be readily | | |
| | up to 1% associated | provided | | |
| | with the AFE to FE | | | |
| | phase transition. | | | |
| Electrostatic | Conductive plates are | Low power | Difficult to operate | IJ02, IJ04 |
| plates | separated by a | consumption | electrostatic devices | |
| | compressible or fluid | Many ink types can | in an aqueous | |
| | dielectric (usually air). | be used | environment | |
| | Upon application of a | Fast operation | The electrostatic | |
| | voltage, the plates | | actuator will | |
| | attract each other and | | normally need to be | |
| | displace ink, causing | | separated from the | |
| | drop ejection. The | | ink | |
| | conductive plates may | | Very large area | |
| | be in a comb or | | required to achieve | |
| | honeycomb structure, | | high forces | |
| | or stacked to increase | | High voltage drive | |
| | the surface area and | | transistors may be | |
| | therefore the force. | | required | |
| | | | Full pagewidth print | |
| | | | heads are not | |
| | | | competitive due to | |
| | | | actuator size | |
| Electrostatic | A strong electric field | Low current | High voltage | 1989 Saito et al, |
| pull | is applied to the ink, | consumption | required | USP 4,799,068 |
| on ink | whereupon | Low temperature | May be damaged by | 1989 Miura et al, |
| | electrostatic attraction | | sparks due to air | USP 4,810,954 |
| | accelerates the ink | | breakdown | Tone-jet |
| | towards the print | | Required field | |
| | medium. | | strength increases as | |
| | | | the drop size | |
| | | | decreases | |
| | | | High voltage drive | |
| | | | transistors required | |
| | | | Electrostatic field | |
| | | | attracts dust | |
| Permanent | An electromagnet | Low power | Complex fabrication | IJ07, IJ10 |
| magnet | directly attracts a | consumption | Permanent magnetic | |
| electromagnetic | permanent magnet, | Many ink types can | material such as | |
| | displacing ink and | be used | Neodymium Iron | |
| | causing drop ejection. | Fast operation | Boron (NdFeB) | |
| | Rare earth magnets | High efficiency | required. | |
| | with a field strength | Easy extension from | High local currents | |
| | around 1 Tesla can be | single nozzles to | required | |
| | used. Examples are: | pagewidth print | Copper metalization | |
| | Samarium Cobalt | heads | should be used for | |
| | (SaCo) and magnetic | | long | |
| | materials in the | | electromigration | |
| | neodymium iron boron | | lifetime and low | |
| | family (NdFeB, | | resistivity | |
| | NdDyFeBNb, | | Pigmented inks are | |
| | NdDyFeB, etc) | | usually infeasible | |
| | | | Operating | |
| | | | temperature limited | |
| | | | to the Curie | |
| | | | temperature (around | |
| | | | 540K) | |
| Soft | A solenoid induced a | Low power | Complex fabrication | IJ01, IJ05, IJ08, |
| magnetic | magnetic field in a soft | consumption | Materials not | IJ10, IJ12, IJ14, |
| core | magnetic core or yoke | Many ink types can | usually present in a | IJ15, IJ17 |
| electromagnetic | fabricated from a | be used | CMOS fab such as | |
| | ferrous material such | Fast operation | NiFe, CoNiFe, or | |
| | as electroplated iron | High efficiency | CoFe are required | |
| | alloys such as CoNiFe | Easy extension from | High local currents | |
| | [1], CoFe, or NiFe | single nozzles to | required | |
| | alloys. Typically, the | pagewidth print | Copper metalization | |
| | soft magnetic material | heads | should be used for | |
| | is in two parts, which | | long | |
| | are normally held | | electromigration | |
| | apart by a spring. | | lifetime and low | |
| | When the solenoid is | | resistivity | |
| | actuated, the two parts | | Electroplating is | |
| | attract, displacing the | | required | |
| | ink. | | High saturation flux | |
| | | | density is required | |
| | | | (2.0-2.1 T is | |
| | | | achievable with | |
| | | | CoNiFe [1]) | |
| Lorenz | The Lorenz force | Low power | Force acts as a | IJ06, IJ11, IJ13, |
| force | acting on a current | consumption | twisting motion | IJ16 |
| | carrying wire in a | Many ink types can | Typically, only a | |
| | magnetic field is | be used | quarter of the | |
| | utilized. | Fast operation | solenoid length | |
| | This allows the | High efficiency | provides force in a | |
| | magnetic field to be | Easy extension from | useful direction | |
| | supplied externally to | single nozzles to | High local currents | |
| | the print head, for | pagewidth print | required | |
| | example with rare | heads | Copper metalization | |
| | earth permanent | | should be used for | |
| | magnets. | | long | |
| | Only the current | | electromigration | |
| | carrying wire need be | | lifetime and low | |
| | fabricated on the print- | | resistivity | |
| | head, simplifying | | Pigmented inks are | |
| | materials | | usually infeasible | |
| | requirements. | | | |
| Magneto- | The actuator uses the | Many ink types can | Force acts as a | Fischenbeck, USP |
| striction | giant magnetostrictive | be used | twisting motion | 4,032,929 |
| | effect of materials | Fast operation | Unusual materials | IJ25 |
| | such as Terfenol-D (an | Easy extension from | such as Terfenol-D | |
| | alloy of terbium, | single nozzles to | are required | |
| | dysprosium and iron | pagewidth print | High local currents | |
| | developed at the Naval | heads | required | |
| | Ordnance Laboratory, | High force is | Copper metalization | |
| | hence Ter-Fe-NOL). | available | should be used for | |
| | For best efficiency, the | | long | |
| | actuator should be pre- | | electromigration | |
| | stressed to approx. 8 MPa. | | lifetime and low | |
| | | | resistivity | |
| | | | Pre-stressing may | |
| | | | be required | |
| Surface | Ink under positive | Low power | Requires | Silverbrook, EP |
| tension | pressure is held in a | consumption | supplementary force | 0771 658 A2 and |
| reduction | nozzle by surface | Simple construction | to effect drop | related patent |
| | tension. The surface | No unusual | separation | applications |
| | tension of the ink is | materials required in | Requires special ink | |
| | reduced below the | fabrication | surfactants | |
| | bubble threshold, | High efficiency | Speed may be | |
| | causing the ink to | Easy extension from | limited by surfactant | |
| | egress from the | single nozzles to | properties | |
| | nozzle. | pagewidth print | | |
| | | heads | | |
| Viscosity | The ink viscosity is | Simple construction | Requires | Silverbrook, EP |
| reduction | locally reduced to | No unusual | supplementary force | 0771 658 A2 and |
| | select which drops are | materials required in | to effect drop | related patent |
| | to be ejected. A | fabrication | separation | applications |
| | viscosity reduction can | Easy extension from | Requires special ink | |
| | be achieved | single nozzles to | viscosity properties | |
| | electrothermally with | pagewidth print | High speed is | |
| | most inks, but special | heads | difficult to achieve | |
| | inks can be engineered | | Requires oscillating | |
| | for a 100:1 viscosity | | ink pressure | |
| | reduction. | | A high temperature | |
| | | | difference (typically | |
| | | | 80 degrees) is | |
| | | | required | |
| Acoustic | An acoustic wave is | Can operate without | Complex drive | 1993 Hadimioglu et |
| | generated and | a nozzle plate | circuitry | al, EUP 550,192 |
| | focussed upon the | | Complex fabrication | 1993 Elrod et al, |
| | drop ejection region. | | Low efficiency | EUP 572,220 |
| | | | Poor control of drop | |
| | | | position | |
| | | | Poor control of drop | |
| | | | volume | |
| Thermoelastic | An actuator which | Low power | Efficient aqueous | IJ03, IJ09, IJ17, |
| bend | relies upon differential | consumption | operation requires a | IJ18, IJ19, IJ20, |
| actuator | thermal expansion | Many ink types can | thermal insulator on | IJ21, IJ22, IJ23, |
| | upon Joule heating is | be used | the hot side | IJ24, IJ27, IJ28, |
| | used. | Simple planar | Corrosion | IJ29, IJ30, IJ31, |
| | | fabrication | prevention can be | IJ32, IJ33, IJ34, |
| | | Small chip area | difficult | IJ35, IJ36, IJ37, |
| | | required for each | Pigmented inks may | IJ38, IJ39, IJ40, |
| | | actuator | be infeasible, as | IJ41 |
| | | Fast operation | pigment particles | |
| | | High efficiency | may jam the bend | |
| | | CMOS compatible | actuator | |
| | | voltages and | | |
| | | currents | | |
| | | Standard MEMS | | |
| | | processes can be | | |
| | | used | | |
| | | Easy extension from | | |
| | | single nozzles to | | |
| | | pagewidth print | | |
| | | heads | | |
| High CTE | A material with a very | High force can be | Requires special | IJ09, IJ17, IJ18, |
| thermoelastic | high coefficient of | generated | material (e.g. PTFE) | IJ20, IJ21, IJ22, |
| actuator | thermal expansion | Three methods of | Requires a PTFE | IJ23, IJ24, IJ27, |
| | (CTE) such as | PTFE deposition are | deposition process, | IJ28, IJ29, IJ30, |
| | polytetrafluoroethylen | under development: | which is not yet | IJ31, IJ42, IJ43, |
| | e (PTFE) is used. As | chemical vapor | standard in ULSI | IJ44 |
| | high CTE materials | deposition (CVD), | fabs | |
| | are usually non- | spin coating, and | PTFE deposition | |
| | conductive, a heater | evaporation | cannot be followed | |
| | fabricated from a | PTFE is a candidate | with high | |
| | conductive material is | for low dielectric | temperature (above | |
| | incorporated. A 50 μm | constant insulation | 350° C.) processing | |
| | long PTFE bend | in ULSI | Pigmented inks may | |
| | actuator with | Very low power | be infeasible, as | |
| | polysilicon heater and | consumption | pigment particles | |
| | 15 mW power input | Many ink types can | may jam the bend | |
| | can provide 180 μN | be used | actuator | |
| | force and 10 μm | Simple planar | | |
| | deflection. Actuator | fabrication | | |
| | motions include: | Small chip area | | |
| | Bend | required for each | | |
| | Push | actuator | | |
| | Buckle | Fast operation | | |
| | Rotate | High efficiency | | |
| | | CMOS compatible | | |
| | | voltages and | | |
| | | currents | | |
| | | Easy extension from | | |
| | | single nozzles to | | |
| | | pagewidth print | | |
| | | heads | | |
| Conductive | A polymer with a high | High force can be | Requires special | IJ24 |
| polymer | coefficient of thermal | generated | materials | |
| thermoelastic | expansion (such as | Very low power | development (High | |
| actuator | PTFE) is doped with | consumption | CTE conductive | |
| | conducting substances | Many ink types can | polymer) | |
| | to increase its | be used | Requires a PTFE | |
| | conductivity to about 3 | Simple planar | deposition process, | |
| | orders of magnitude | fabrication | which is not yet | |
| | below that of copper. | Small chip area | standard in ULSI | |
| | The conducting | required for each | fabs | |
| | polymer expands | actuator | PTFE deposition | |
| | when resistively | Fast operation | cannot be followed | |
| | heated. | High efficiency | with high | |
| | Examples of | CMOS compatible | temperature (above | |
| | conducting dopants | voltages and | 350° C.) processing | |
| | include: | currents | Evaporation and | |
| | Carbon nanotubes | Easy extension from | CVD deposition | |
| | Metal fibers | single nozzles to | techniques cannot | |
| | Conductive polymers | pagewidth print | be used | |
| | such as doped | heads | Pigmented inks may | |
| | polythiophene | | be infeasible, as | |
| | Carbon granules | | pigment particles | |
| | | | may jam the bend | |
| | | | actuator | |
| Shape | A shape memory alloy | High force is | Fatigue limits | IJ26 |
| memory | such as TiNi (also | available (stresses | maximum number | |
| alloy | known as Nitinol — | of hundreds of MPa) | of cycles | |
| | Nickel Titanium alloy | Large strain is | Low strain (1%) is | |
| | developed at the Naval | available (more than | required to extend | |
| | Ordnance Laboratory) | 3%) | fatigue resistance | |
| | is thermally switched | High corrosion | Cycle rate limited | |
| | between its weak | resistance | by heat removal | |
| | martensitic state and | Simple construction | Requires unusual | |
| | its high stiffness | Easy extension from | materials (TiNi) | |
| | austenic state. The | single nozzles to | The latent heat of | |
| | shape of the actuator | pagewidth print | transformation must | |
| | in its martensitic state | heads | be provided | |
| | is deformed relative to | Low voltage | High current | |
| | the austenic shape. | operation | operation | |
| | The shape change | | Requires pre- | |
| | causes ejection of a | | stressing to distort | |
| | drop. | | the martensitic state | |
| Linear | Linear magnetic | Linear Magnetic | Requires unusual | IJ12 |
| Magnetic | actuators include the | actuators can be | semiconductor | |
| Actuator | Linear Induction | constructed with | materials such as | |
| | Actuator (LIA), Linear | high thrust, long | soft magnetic alloys | |
| | Permanent Magnet | travel, and high | (e.g. CoNiFe) | |
| | Synchronous Actuator | efficiency using | Some varieties also | |
| | (LPMSA), Linear | planar | require permanent | |
| | Reluctance | semiconductor | magnetic materials | |
| | Synchronous Actuator | fabrication | such as Neodymium | |
| | (LRSA), Linear | techniques | iron boron (NdFeB) | |
| | Switched Reluctance | Long actuator travel | Requires complex | |
| | Actuator (LSRA), and | is available | multi-phase drive | |
| | the Linear Stepper | Medium force is | circuitry | |
| | Actuator (LSA). | available | High current | |
| | | Low voltage | operation | |
| | | operation | | |

BASIC OPERATION MODE

| Operational | | | | |
|---|---|---|---|---|
| mode | Description | Advantages | Disadvantages | Examples |
| Actuator | This is the simplest | Simple operation | Drop repetition rate | Thermal ink jet |
| directly | mode of operation: the | No external fields | is usually limited to | Piezoelectric ink jet |
| pushes ink | actuator directly | required | around 10 kHz. | IJ01, IJ02, IJ03, |
| | supplies sufficient | Satellite drops can | However, this is not | IJ04, IJ05, IJ06, |
| | kinetic energy to expel | be avoided if drop | fundamental to the | IJ07, IJ09, IJ11, |
| | the drop. The drop | velocity is less than | method, but is | IJ12, IJ14, IJ16, |
| | must have a sufficient | 4 m/s | related to the refill | IJ20, IJ22, IJ23, |
| | velocity to overcome | Can be efficient, | method normally | IJ24, IJ25, IJ26, |
| | the surface tension. | depending upon the | used | IJ27, IJ28, IJ29, |
| | | actuator used | All of the drop | IJ30, IJ31, IJ32, |
| | | | kinetic energy must | IJ33, IJ34, IJ35, |
| | | | be provided by the | IJ36, IJ37, IJ38, |
| | | | actuator | IJ39, IJ40, IJ41, |
| | | | Satellite drops | IJ42, IJ43, IJ44 |
| | | | usually form if drop | |
| | | | velocity is greater | |
| | | | than 4.5 m/s | |
| Proximity | The drops to be | Very simple print | Requires close | Silverbrook, EP |
| | printed are selected by | head fabrication can | proximity between | 0771 658 A2 and |
| | some manner (e.g. | be used | the print head and | related patent |
| | thermally induced | The drop selection | the print media or | applications |
| | surface tension | means does not need | transfer roller | |
| | reduction of | to provide the | May require two | |
| | pressurized ink). | energy required to | print heads printing | |
| | Selected drops are | separate the drop | alternate rows of the | |
| | separated from the ink | from the nozzle | image | |
| | in the nozzle by | | Monolithic color | |
| | contact with the print | | print heads are | |
| | medium or a transfer | | difficult | |
| | roller. | | | |
| Electrostatic | The drops to be | Very simple print | Requires very high | Silverbrook, EP |
| pull | printed are selected by | head fabrication can | electrostatic field | 0771 658 A2 and |
| on ink | some manner (e.g. | be used | Electrostatic field | related patent |
| | thermally induced | The drop selection | for small nozzle | applications |
| | surface tension | means does not need | sizes is above air | Tone-Jet |
| | reduction of | to provide the | breakdown | |
| | pressurized ink). | energy required to | Electrostatic field | |
| | Selected drops are | separate the drop | may attract dust | |
| | separated from the ink | from the nozzle | | |
| | in the nozzle by a | | | |
| | strong electric field. | | | |
| Magnetic | The drops to be | Very simple print | Requires magnetic | Silverbrook, EP |
| pull on ink | printed are selected by | head fabrication can | ink | 0771 658 A2 and |
| | some manner (e.g. | be used | Ink colors other than | related patent |
| | thermally induced | The drop selection | black are difficult | applications |
| | surface tension | means does not need | Requires very high | |
| | reduction of | to provide the | magnetic fields | |
| | pressurized ink). | energy required to | | |
| | Selected drops are | separate the drop | | |
| | separated from the ink | from the nozzle | | |
| | in the nozzle by a | | | |
| | strong magnetic field | | | |
| | acting on the magnetic | | | |
| | ink. | | | |
| Shutter | The actuator moves a | High speed (>50 | Moving parts are | IJ13, IJ17, IJ21 |
| | shutter to block ink | kHz) operation can | required | |
| | flow to the nozzle. The | be achieved due to | Requires ink | |
| | ink pressure is pulsed | reduced refill time | pressure modulator | |
| | at a multiple of the | Drop timing can be | Friction and wear | |
| | drop ejection | very accurate | must be considered | |
| | frequency. | The actuator energy | Stiction is possible | |
| | | can be very low | | |
| Shuttered | The actuator moves a | Actuators with | Moving parts are | IJ08, IJ15, IJ18, |
| grill | shutter to block ink | small travel can be | required | IJ19 |
| | flow through a grill to | used | Requires ink | |
| | the nozzle. The shutter | Actuators with | pressure modulator | |
| | movement need only | small force can be | Friction and wear | |
| | be equal to the width | used | must be considered | |
| | of the grill holes. | High speed (>50 | Stiction is possible | |
| | | kHz) operation can | | |
| | | be achieved | | |
| Puls d | A pulsed magnetic | Extremely low | Requires an external | IJ10 |
| magnetic | field attracts an ‘ink | energy operation is | pulsed magnetic | |
| pull on ink | pusher’ at the drop | possible | field | |
| pusher | ejection frequency. An | No heat dissipation | Requires special | |
| | actuator controls a | problems | materials for both | |
| | catch, which prevents | | the actuator and the | |
| | the ink pusher from | | ink pusher | |
| | moving when a drop is | | Complex | |
| | not to be ejected. | | construction | |

AUXILIARY MECHANISM (APPLIED TO ALL NOZZLES)

| Auxiliary | | | | |
|---|---|---|---|---|
| Mechanism | Description | Advantages | Disadvantages | Examples |
| None | The actuator directly | Simplicity of | Drop ejection | Most ink jets, |
| | fires the ink drop, and | construction | energy must be | including |
| | there is no external | Simplicity of | supplied by | piezoelectric and |
| | field or other | operation | individual nozzle | thermal bubble. |
| | mechanism required. | Small physical size | actuator | IJ01, IJ02, IJ03, |
| | | | | IJ04, IJ05, IJ07, |
| | | | | IJ09, IJ11, IJ12, |
| | | | | IJ14, IJ20, IJ22, |
| | | | | IJ23, IJ24, IJ25, |
| | | | | IJ26, IJ27, IJ28, |
| | | | | IJ29, IJ30, IJ31, |
| | | | | IJ32, IJ33, IJ34, |
| | | | | IJ35, IJ36, IJ37, |
| | | | | IJ38, IJ39, IJ40, |
| | | | | IJ41, IJ42, IJ43, |
| | | | | IJ44 |
| Oscillating | The ink pressure | Oscillating ink | Requires external | Silverbrook, EP |
| ink | oscillates, providing | pressure can provide | ink pressure | 0771 658 A2 and |
| pressure | much of the drop | a refill pulse, | oscillator | related patent |
| (including | ejection energy. The | allowing higher | Ink pressure phase | applications |
| acoustic | actuator selects which | operating speed | and amplitude must | IJ08, IJ13, IJ15, |
| stimulation) | drops are to be fired | The actuators may | be carefully | IJ17, IJ18, IJ19, |
| | by selectively | operate with much | controlled | IJ21 |
| | blocking or enabling | lower energy | Acoustic reflections | |
| | nozzles. The ink | Acoustic lenses can | in the ink chamber | |
| | pressure oscillation | be used to focus the | must be designed | |
| | may be achieved by | sound on the | for | |
| | vibrating the print | nozzles | | |
| | head, or preferably by | | | |
| | an actuator in the ink | | | |
| | supply. | | | |
| Media | The print head is | Low power | Precision assembly | Silverbrook, EP |
| proximity | placed in close | High accuracy | required | 0771 658 A2 and |
| | proximity to the print | Simple print head | Paper fibers may | related patent |
| | medium. Selected | construction | cause problems | applications |
| | drops protrude from | | Cannot print on | |
| | the print head further | | rough substrates | |
| | than unselected drops, | | | |
| | and contact the print | | | |
| | medium. The drop | | | |
| | soaks into the medium | | | |
| | fast enough to cause | | | |
| | drop separation. | | | |
| Transfer | Drops are printed to a | High accuracy | Bulky | Silverbrook, EP |
| roller | transfer roller instead | Wide range of print | Expensive | 0771 658 A2 and |
| | of straight to the print | substrates can be | Complex | related patent |
| | medium. A transfer | used | construction | applications |
| | roller can also be used | Ink can be dried on | | Tektronix hot melt |
| | for proximity drop | the transfer roller | | piezoelectric ink jet |
| | separation. | | | Any of the IJ series |
| Electrotatic | An electric field is | Low power | Field strength | Silverbrook, EP |
| | used to accelerate | Simple print head | required for | 0771 658 A2 and |
| | selected drops towards | construction | separation of small | related patent |
| | the print medium. | | drops is near or | applications |
| | | | above air | Tone-Jet |
| | | | breakdown | |
| Direct | A magnetic field is | Low power | Requires magnetic | Silverbrook, EP |
| magnetic | used to accelerate | Simple print head | ink | 0771 658 A2 and |
| field | selected drops of | construction | Requires strong | related patent |
| | magnetic ink towards | | magnetic field | applications |
| | the print medium. | | | |
| Cross | The print head is | Does not require | Requires external | IJ06, IJ16 |
| magnetic | placed in a constant | magnetic materials | magnet | |
| field | magnetic field. The | to be integrated in | Current densities | |
| | Lorenz force in a | the print head | may be high, | |
| | current carrying wire | manufacturing | resulting in | |
| | is used to move the | process | electromigration | |
| | actuator. | | problems | |
| Pulsed | A pulsed magnetic | Very low power | Complex print head | IJ10 |
| magnetic | field is used to | operation is possible | construction | |
| field | cyclically attract a | Small print head | Magnetic materials | |
| | paddle, which pushes | size | required in print | |
| | on the ink. A small | | head | |
| | actuator moves a | | | |
| | catch, which | | | |
| | selectively prevents | | | |
| | the paddle from | | | |
| | moving. | | | |

ACTUATOR AMPLIFICATION OR MODIFICATION METHOD

| Actuator | | | | |
|---|---|---|---|---|
| amplification | Description | Advantages | Disadvantages | Examples |
| None | No actuator | Operational | Many actuator | Thermal Bubble Ink |
| | mechanical | simplicity | mechanisms have | jet |
| | amplification is used. | | insufficient travel, | IJ01, IJ02, IJ06, |
| | The actuator directly | | or insufficient force, | IJ07, IJ16, IJ25, |
| | drives the drop | | to efficiently drive | IJ26 |
| | ejection process. | | the drop ejection | |
| | | | process | |
| Differential | An actuator material | Provides greater | High stresses are | Piezoelectric |
| expansion | expands more on one | travel in a reduced | involved | IJ03, IJ09, IJ17, |
| bend | side than on the other. | print head area | Care must be taken | IJ18, IJ19, IJ20, |
| actuator | The expansion may be | | that the materials do | IJ21, IJ22, IJ23, |
| | thermal, piezoelectric, | | not delaminate | IJ24, IJ27, IJ29, |
| | magnetostrictive, or | | Residual bend | IJ30, IJ31, IJ32, |
| | other mechanism. The | | resulting from high | IJ33, IJ34, IJ35, |
| | bend actuator converts | | temperature or high | IJ36, IJ37, IJ38, |
| | a high force low travel | | stress during | IJ39, IJ42, IJ43, |
| | actuator mechanism to | | formation | IJ44 |
| | high travel, lower | | | |
| | force mechanism. | | | |
| Transient | A trilayer bend | Very good | High stresses are | IJ40, IJ41 |
| bend | actuator where the two | temperature stability | involved | |
| actuator | outside layers are | High speed, as a | Care must be taken | |
| | identical. This cancels | new drop can be | that the materials do | |
| | bend due to ambient | fired before heat | not delaminate | |
| | temperature and | dissipates | | |
| | residual stress. The | Cancels residual | | |
| | actuator only responds | stress of formation | | |
| | to transient heating of | | | |
| | one side or the other. | | | |
| Reverse | The actuator loads a | Better coupling to | Fabrication | IJ05, IJ11 |
| spring | spring. When the | the ink | complexity | |
| | actuator is turned off, | | High stress in the | |
| | the spring releases. | | spring | |
| | This can reverse the | | | |
| | force/distance curve of | | | |
| | the actuator to make it | | | |
| | compatible with the | | | |
| | force/time | | | |
| | requirements of the | | | |
| | drop ejection. | | | |
| Actuator | A series of thin | Increased travel | Increased | Some piezoelectric |
| stack | actuators are stacked. | Reduced drive | fabrication | ink jets |
| | This can be | voltage | complexity | IJ04 |
| | appropriate where | | Increased possibility | |
| | actuators require high | | of short circuits due | |
| | electric field strength, | | to pinholes | |
| | such as electrostatic | | | |
| | and piezoelectric | | | |
| | actuators | | | |
| Multiple | Multiple smaller | Increases the force | Actuator forces may | IJ12, IJ13, IJ18, |
| actuators | actuators are used | available from an | not add linearly, | IJ20, IJ22, IJ28, |
| | simultaneously to | actuator | reducing efficiency | IJ42, IJ43 |
| | move the ink. Each | Multiple actuators | | |
| | actuator need provide | can be positioned to | | |
| | only a portion of the | control ink flow | | |
| | force required. | accurately | | |
| Linear | A linear spring is used | Matches low travel | Requires print head | IJ15 |
| Spring | to transform a motion | actuator with higher | area for the spring | |
| | with small travel and | travel requirements | | |
| | high force into a | Non-contact method | | |
| | longer travel, lower | of motion | | |
| | force motion. | transformation | | |
| Coiled | A bend actuator is | Increases travel | Generally restricted | IJ17, IJ21, IJ34, |
| actuator | coiled to provide | Reduces chip area | to planar | IJ35 |
| | greater travel in a | Planar | implementations | |
| | reduced chip area. | implementations are | due to extreme | |
| | | relatively easy to | fabrication difficulty | |
| | | fabricate. | in other orientations. | |
| Flexure | A bend actuator has a | Simple means of | Care must be taken | IJ10, IJ19,IJ33 |
| bend | small region near the | increasing travel of | not to exceed the | |
| actuator | fixture point, which | a bend actuator | elastic limit in the | |
| | flexes much more | | flexure area | |
| | readily than the | | Stress distribution is | |
| | remainder of the | | very uneven | |
| | actuator. The actuator | | Difficult to | |
| | flexing is effectively | | accurately model | |
| | converted from an | | with finite element | |
| | even coiling to an | | analysis | |
| | angular bend, resulting | | | |
| | in greater travel of the | | | |
| | actuator tip. | | | |
| Catch | The actuator controls a | Very low actuator | Complex | IJ10 |
| | small catch. The catch | energy | construction | |
| | either enables or | Very small actuator | Requires external | |
| | disables movement of | size | force | |
| | an ink pusher that is | | Unsuitable for | |
| | controlled in a bulk | | pigmented inks | |
| | manner. | | | |
| Gears | Gears can be used to | Low force, low | Moving parts are | IJ13 |
| | increase travel at the | travel actuators can | required | |
| | expense of duration. | be used | Several actuator | |
| | Circular gears, rack | Can be fabricated | cycles are required | |
| | and pinion, ratchets, | using standard | More complex drive | |
| | and other gearing | surface MEMS | electronics | |
| | methods can be used. | processes | Complex | |
| | | | construction | |
| | | | Friction, friction, | |
| | | | and wear are | |
| | | | possible | |
| Buckle | A buckle plate can be | Very fast movement | Must stay within | S. Hirata et al, “An |
| plate | used to change a slow | achievable | elastic limits of the | Ink-jet Head Using |
| | actuator into a fast | | materials for long | Diaphragm |
| | motion. It can also | | device life | Microactuator”, |
| | convert a high force, | | High stresses | Proc. IEEE MEMS, |
| | low travel actuator | | involved | Feb. 1996, pp 418-423. |
| | into a high travel, | | Generally high | IJ18, IJ27 |
| | medium force motion. | | power requirement | |
| Tapered | A tapered magnetic | Linearizes the | Complex | IJ14 |
| magnetic | pole can increase | magnetic | construction | |
| pole | travel at the expense | force/distance curve | | |
| | of force. | | | |
| Lever | A lever and fulcrum is | Matches low travel | High stress around | IJ32, IJ36, IJ37 |
| | used to transform a | actuator with higher | the fulcrum | |
| | motion with small | travel requirements | | |
| | travel and high force | Fulcrum area has no | | |
| | into a motion with | linear movement, | | |
| | longer travel and | and can be used for | | |
| | lower force. The lever | a fluid seal | | |
| | can also reverse the | | | |
| | direction of travel. | | | |
| Rotary | The actuator is | High mechanical | Complex | IJ28 |
| impeller | connected to a rotary | advantage | construction | |
| | impeller. A small | The ratio of force to | Unsuitable for | |
| | angular deflection of | travel of the actuator | pigmented inks | |
| | the actuator results in | can be matched to | | |
| | a rotation of the | the nozzle | | |
| | impeller vanes, which | requirements by | | |
| | push the ink against | varying the number | | |
| | stationary vanes and | of impeller vanes | | |
| | out of the nozzle. | | | |
| Acoustic | A refractive or | No moving parts | Large area required | 1993 Hadimioglu et |
| lens | diffractive (e.g. zone | | Only relevant for | al, EUP 550,192 |
| | plate) acoustic lens is | | acoustic ink jets | 1993 Elrod et al, |
| | used to concentrate | | | EUP 572,220 |
| | sound waves. | | | |
| Sharp | A sharp point is used | Simple construction | Difficult to fabricate | Tone-jet |
| conductive | to concentrate an | | using standard VLSI | |
| point | electrostatic field. | | processes for a | |
| | | | surface ejecting ink- | |
| | | | jet | |
| | | | Only relevant for | |
| | | | electrostatic ink jets | |

ACTUATOR MOTION

| Actuator | | | | |
|---|---|---|---|---|
| motion | Description | Advantages | Disadvantages | Examples |
| Volume | The volume of the | Simple construction | High energy is | Hewlett-Packard |
| expansion | actuator changes, | in the case of | typically required to | Thermal Ink jet |
| | pushing the ink in all | thermal ink jet | achieve volume | Canon Bubblejet |
| | directions. | | expansion. This | |
| | | | leads to thermal | |
| | | | stress, cavitation, | |
| | | | and kogation in | |
| | | | thermal ink jet | |
| | | | implementations | |
| Linear, | The actuator moves in | Efficient coupling to | High fabrication | IJ01, IJ02, 1J04, |
| normal to | a direction normal to | ink drops ejected | complexity may be | IJ07, IJ11, IJ14 |
| chip | the print head surface. | normal to the | required to achieve | |
| surface | The nozzle is typically | surface | perpendicular | |
| | in the line of | | motion | |
| | movement. | | | |
| Parallel to | The actuator moves | Suitable for planar | Fabrication | IJ12, IJ13, IJ15, |
| chip | parallel to the print | fabrication | complexity | IJ33, , IJ34, IJ35, |
| surface | head surface. Drop | | Friction | IJ36 |
| | ejection may still be | | Stiction | |
| | normal to the surface. | | | |
| Membrane | An actuator with a | The effective area of | Fabrication | 1982 Howkins USP |
| push | high force but small | the actuator | complexity | 4,459,601 |
| | area is used to push a | becomes the | Actuator size | |
| | stiff membrane that is | membrane area | Difficulty of | |
| | in contact with the ink. | | integration in a | |
| | | | VLSI process | |
| Rotary | The actuator causes | Rotary levers may | Device complexity | IJ05, IJ08, IJ13, |
| | the rotation of some | be used to increase | May have friction at | IJ28 |
| | element, such a grill or | travel | a pivot point | |
| | impeller | Small chip area | | |
| | | requirements | | |
| Bend | The actuator bends | A very small change | Requires the | 1970 Kyser et al |
| | when energized. This | in dimensions can | actuator to be made | USP 3,946,398 |
| | may be due to | be converted to a | from at least two | 1973 Stemme USP |
| | differential thermal | large motion. | distinct layers, or to | 3,747,120 |
| | expansion, | | have a thermal | IJ03, IJ09, IJ10, |
| | piezoelectric | | difference across the | IJ19, IJ23, IJ24, |
| | expansion, | | actuator | IJ25, IJ29, IJ30, |
| | magnetostriction, or | | | IJ31, IJ33, IJ34, |
| | other form of relative | | | IJ35 |
| | dimensional change. | | | |
| Swivel | The actuator swivels | Allows operation | Inefficient coupling | IJ06 |
| | around a central pivot. | where the net linear | to the ink motion | |
| | This motion is suitable | force on the paddle | | |
| | where there are | is zero | | |
| | opposite forces | Small chip area | | |
| | applied to opposite | requirements | | |
| | sides of the paddle, | | | |
| | e.g. Lorenz force. | | | |
| Straighten | The actuator is | Can be used with | Requires careful | IJ26, IJ32 |
| | normally bent, and | shape memory | balance of stresses | |
| | straightens when | alloys where the | to ensure that the | |
| | energized. | austenic phase is | quiescent bend is | |
| | | planar | accurate | |
| Double | The actuator bends in | One actuator can be | Difficult to make | IJ36, IJ37, IJ38 |
| bend | one direction when | used to power two | the drops ejected by | |
| | one element is | nozzles. | both bend directions | |
| | energized, and bends | Reduced chip size. | identical. | |
| | the other way when | Not sensitive to | A small efficiency | |
| | another element is | ambient temperature | loss compared to | |
| | energized. | | equivalent single | |
| | | | bend actuators. | |
| Shear | Energizing the | Can increase the | Not readily | 1985 Fishbeck USP |
| | actuator causes a shear | effective travel of | applicable to other | 4,584,590 |
| | motion in the actuator | piezoelectric | actuator | |
| | material. | actuators | mechanisms | |
| Radial | The actuator squeezes | Relatively easy to | High force required | 1970 Zoltan USP |
| constriction | an ink reservoir, | fabricate single | Inefficient | 3,683,212 |
| | forcing ink from a | nozzles from glass | Difficult to integrate | |
| | constricted nozzle. | tubing as | with VLSI | |
| | | macroscopic | processes | |
| | | structures | | |
| Coil/ | A coiled actuator | Easy to fabricate as | Difficult to fabricate | IJ17, IJ21, IJ34, |
| uncoil | uncoils or coils more | a planar VLSI | for non-planar | IJ35 |
| | tightly. The motion of | process | devices | |
| | the free end of the | Small area required, | Poor out-of-plane | |
| | actuator ejects the ink. | therefore low cost | stiffness | |
| Bow | The actuator bows (or | Can increase the | Maximum travel is | IJ16, IJ18, IJ27 |
| | buckles) in the middle | speed of travel | constrained | |
| | when energized. | Mechanically rigid | High force required | |
| Push-Pull | Two actuators control | The structure is | Not readily suitable | IJ18 |
| | a shutter. One actuator | pinned at both ends, | for ink jets which | |
| | pulls the shutter, and | so has a high out-of- | directly push the ink | |
| | the other pushes it. | plane rigidity | | |
| Curl | A set of actuators curl | Good fluid flow to | Design complexity | IJ20, IJ42 |
| inwards | inwards to reduce the | the region behind | | |
| | volume of ink that | the actuator | | |
| | they enclose. | increases efficiency | | |
| Curl | A set of actuators curl | Relatively simple | Relatively large | IJ43 |
| outwards | outwards, pressurizing | construction | chip area | |
| | ink in a chamber | | | |
| | surrounding the | | | |
| | actuators, and | | | |
| | expelling ink from a | | | |
| | nozzle in the chamber. | | | |
| Iris | Multiple vanes enclose | High efficiency | High fabrication | IJ22 |
| | a volume of ink. These | Small chip area | complexity | |
| | simultaneously rotate, | | Not suitable for | |
| | reducing the volume | | pigmented inks | |
| | between the vanes. | | | |
| Acoustic | The actuator vibrates | The actuator can be | Large area required | 1993 Hadimioglu et |
| vibration | at a high frequency. | physically distant | for efficient | al, EUP 550,192 |
| | | from the ink | operation at useful | 1993 Elrod et al, |
| | | | frequencies | EUP 572,220 |
| | | | Acoustic coupling | |
| | | | and crosstalk | |
| | | | Complex drive | |
| | | | circuitry | |
| | | | Poor control of drop | |
| | | | volume and position | |
| None | In various ink jet | No moving parts | Various other | Silverbrook, EP |
| | designs the actuator | | tradeoffs are | 0771 658 A2 and |
| | does not move. | | required to | related patent |
| | | | eliminate moving | applications |
| | | | parts | Tone-jet |

NOZZLE REFILL METHOD

| Nozzle refill | | | | |
|---|---|---|---|---|
| method | Description | Advantages | Disadvantages | Examples |
| Surface | This is the normal way | Fabrication | Low speed | Thermal ink jet |
| tension | that ink jets are | simplicity | Surface tension | Piezoelectric ink jet |
| | refilled. After the | Operational | force relatively | IJ01-IJ07, IJ10-IJ14, |
| | actuator is energized, | simplicity | small compared to | IJ16, IJ20, IJ22-IJ45 |
| | it typically returns | | actuator force | |
| | rapidly to its normal | | Long refill time | |
| | position. This rapid | | usually dominates | |
| | return sucks in air | | the total repetition | |
| | through the nozzle | | rate | |
| | opening. The ink | | | |
| | surface tension at the | | | |
| | nozzle then exerts a | | | |
| | small force restoring | | | |
| | the meniscus to a | | | |
| | minimum area. This | | | |
| | force refills the nozzle. | | | |
| Shuttered | Ink to the nozzle | High speed | Requires common | IJ08, IJ13, IJ15, |
| oscillating | chamber is provided at | Low actuator | ink pressure | IJ17, IJ18, IJ19, |
| ink | a pressure that | energy, as the | oscillator | IJ21 |
| pressure | oscillates at twice the | actuator need only | May not be suitable | |
| | drop ejection | open or close the | for pigmented inks | |
| | frequency. When a | shutter, instead of | | |
| | drop is to be ejected, | ejecting the ink drop | | |
| | the shutter is opened | | | |
| | for 3 half cycles: drop | | | |
| | ejection, actuator | | | |
| | return, and refill. The | | | |
| | shutter is then closed | | | |
| | to prevent the nozzle | | | |
| | chamber emptying | | | |
| | during the next | | | |
| | negative pressure | | | |
| | cycle. | | | |
| Refill | After the main | High speed, as the | Requires two | IJ09 |
| actuator | actuator has ejected a | nozzle is actively | independent | |
| | drop a second (refill) | refilled | actuators per nozzle | |
| | actuator is energized. | | | |
| | The refill actuator | | | |
| | pushes ink into the | | | |
| | nozzle chamber. The | | | |
| | refill actuator returns | | | |
| | slowly, to prevent its | | | |
| | return from emptying | | | |
| | the chamber again. | | | |
| Positive | The ink is held a slight | High refill rate, | Surface spill must | Silverbrook, EP |
| ink | positive pressure. | therefore a high | be prevented | 0771 658 A2 and |
| pressure | After the ink drop is | drop repetition rate | Highly hydrophobic | related patent |
| | ejected, the nozzle | is possible | print head surfaces | applications |
| | chamber fills quickly | | are required | Alternative for:, |
| | as surface tension and | | | IJ01-IJ07, IJ10-IJ14, |
| | ink pressure both | | | IJ16, IJ20, IJ22-IJ45 |
| | operate to refill the | | | |
| | nozzle. | | | |

METHOD OF RESTRICTING BACK-FLOW THROUGH INLET

| Inlet back-flow | | | | |
|---|---|---|---|---|
| restriction | | | | |
| method | Description | Advantages | Disadvantages | Examples |
| Long inlet | The ink inlet channel | Design simplicity | Restricts refill rate | Thermal ink jet |
| channel | to the nozzle chamber | Operational | May result in a | Piezoelectric ink jet |
| | is made long and | simplicity | relatively large chip | IJ42, IJ43 |
| | relatively narrow, | Reduces crosstalk | area | |
| | relying on viscous | | Only partially | |
| | drag to reduce inlet | | effective | |
| | back-flow. | | | |
| Positive | The ink is under a | Drop selection and | Requires a method | Silverbrook, EP |
| ink | positive pressure, so | separation forces | (such as a nozzle | 0771 658 A2 and |
| pressure | that in the quiescent | can be reduced | rim or effective | related patent |
| | state some of the ink | Fast refill time | hydrophobizing, or | applications |
| | drop already protrudes | | both) to prevent | Possible operation |
| | from the nozzle. | | flooding of the | of the following: |
| | This reduces the | | ejection surface of | IJ01-IJ07, IJ09-IJ12, |
| | pressure in the nozzle | | the print head. | IJ14, IJ16, |
| | chamber which is | | | IJ20, IJ22, IJ23-IJ34, |
| | required to eject a | | | IJ36-IJ41, |
| | certain volume of ink. | | | IJ44 |
| | The reduction in | | | |
| | chamber pressure | | | |
| | results in a reduction | | | |
| | in ink pushed out | | | |
| | through the inlet. | | | |
| Baffle | One or more baffles | The refill rate is not | Design complexity | HP Thermal Ink Jet |
| | are placed in the inlet | as restricted as the | May increase | Tektronix |
| | ink flow. When the | long inlet method. | fabrication | piezoelectric ink jet |
| | actuator is energized, | Reduces crosstalk | complexity (e.g. | |
| | the rapid ink | | Tektronix hot melt | |
| | movement creates | | Piezoelectric print | |
| | eddies which restrict | | heads). | |
| | the flow through the | | | |
| | inlet. The slower refill | | | |
| | process is unrestricted, | | | |
| | and does not result in | | | |
| | eddies. | | | |
| Flexible | In this method recently | Significantly | Not applicable to | Canon |
| flap | disclosed by Canon, | reduces back-flow | most ink jet | |
| restricts | the expanding actuator | for edge-shooter | configurations | |
| inlet | (bubble) pushes on a | thermal ink jet | Increased | |
| | flexible flap that | devices | fabrication | |
| | restricts the inlet. | | complexity | |
| | | | Inelastic | |
| | | | deformation of | |
| | | | polymer flap results | |
| | | | in creep over | |
| | | | extended use | |
| Inlet filter | A filter is located | Additional | Restricts refill rate | IJ04, IJ12, IJ24, |
| | between the ink inlet | advantage of ink | May result in | IJ27, IJ29, IJ30 |
| | and the nozzle | filtration | complex | |
| | chamber. The filter | Ink filter may be | construction | |
| | has a multitude of | fabricated with no | | |
| | small holes or slots, | additional process | | |
| | restricting ink flow. | steps | | |
| | The filter also removes | | | |
| | particles which may | | | |
| | block the nozzle. | | | |
| Small inlet | The ink inlet channel | Design simplicity | Restricts refill rate | IJ02, IJ37, IJ44 |
| compared | to the nozzle chamber | | May result in a | |
| to nozzle | has a substantially | | relatively large chip | |
| | smaller cross section | | area | |
| | than that of the nozzle, | | Only partially | |
| | resulting in easier ink | | effective | |
| | egress out of the | | | |
| | nozzle than out of the | | | |
| | inlet. | | | |
| Inlet | A secondary actuator | Increases speed of | Requires separate | IJ09 |
| shutter | controls the position of | the ink-jet print | refill actuator and | |
| | a shutter, closing off | head operation | drive circuit | |
| | the ink inlet when the | | | |
| | main actuator is | | | |
| | energized. | | | |
| The inlet is | The method avoids the | Back-flow problem | Requires careful | IJ01, IJ03, IJ05, |
| located | problem of inlet back- | is eliminated | design to minimize | IJ06, IJ07, IJ10, |
| behind the | flow by arranging the | | the negative | IJ11, IJ14, IJ16, |
| ink- | ink-pushing surface of | | pressure behind the | IJ22, IJ23, IJ25, |
| pushing | the actuator between | | paddle | IJ28, IJ31, IJ32, |
| surface | the inlet and the | | | IJ33, IJ34, IJ35, |
| | nozzle. | | | IJ36, IJ39, IJ40, |
| | | | | IJ41 |
| Part of the | The actuator and a | Significant | Small increase in | IJ07, IJ20, IJ26, |
| actuator | wall of the ink | reductions in back- | fabrication | IJ38 |
| moves to | chamber are arranged | flow can be | complexity | |
| shut off | so that the motion of | achieved | | |
| the inlet | the actuator closes off | Compact designs | | |
| | the inlet. | possible | | |
| Nozzle | In some configurations | Ink back-flow | None related to ink | Silverbrook, EP |
| actuator | of ink jet, there is no | problem is | back-flow on | 0771 658 A2 and |
| does not | expansion or | eliminated | actuation | related patent |
| result in | movement of an | | | applications |
| ink back- | actuator which may | | | Valve-jet |
| flow | cause ink back-flow | | | Tone-jet |
| | through the inlet. | | | |

NOZZLE CLEARING METHOD

| Nozzle | | | | |
|---|---|---|---|---|
| Clearing | | | | |
| method | Description | Advantages | Disadvantages | Examples |
| Normal | All of the nozzles are | No added | May not be | Most ink jet systems |
| nozzle | fired periodically, | complexity on the | sufficient to | IJ01, IJ02, IJ03, |
| firing | before the ink has a | print head | displace dried ink | IJ04, IJ05, IJ06, |
| | chance to dry. When | | | IJ07, IJ09, IJ10, |
| | not in use the nozzles | | | IJ11, IJ12, IJ14, |
| | are sealed (capped) | | | IJ16, IJ20, IJ22, |
| | against air. | | | IJ23, IJ24, IJ25, |
| | The nozzle firing is | | | IJ26, IJ27, IJ28, |
| | usually performed | | | IJ29, IJ30, IJ31, |
| | during a special | | | IJ32, IJ33, IJ34, |
| | clearing cycle, after | | | IJ36, IJ37, IJ38, |
| | first moving the print | | | IJ39, IJ40, IJ41, |
| | head to a cleaning | | | IJ42, IJ43, IJ44, |
| | station. | | | IJ45 |
| Extra | In systems which heat | Can be highly | Requires higher | Silverbrook, EP |
| power to | the ink, but do not boil | effective if the | drive voltage for | 0771 658 A2 and |
| ink heater | it under normal | heater is adjacent to | clearing | related patent |
| | situations, nozzle | the nozzle | May require larger | applications |
| | clearing can be | | drive transistors | |
| | achieved by over- | | | |
| | powering the heater | | | |
| | and boiling ink at the | | | |
| | nozzle. | | | |
| Rapid | The actuator is fired in | Does not require | Effectiveness | May be used with: |
| succession | rapid succession. In | extra drive circuits | depends | IJ01, IJ02, IJ03, |
| of | some configurations, | on the print head | substantially upon | IJ04, IJ05, IJ06, |
| actuator | this may cause heat | Can be readily | the configuration of | IJ07, IJ09, IJ10, |
| pulses | build-up at the nozzle | controlled and | the ink jet nozzle | IJ11, IJ14, IJ16, |
| | which boils the ink, | initiated by digital | | IJ20, IJ22, IJ23, |
| | clearing the nozzle. In | logic | | IJ24, IJ25, IJ27, |
| | other situations, it may | | | IJ28, IJ29, IJ30, |
| | cause sufficient | | | IJ31, IJ32, IJ33, |
| | vibrations to dislodge | | | IJ34, IJ36, IJ37, |
| | clogged nozzles. | | | IJ38, IJ39, IJ40, |
| | | | | IJ41, IJ42, IJ43, |
| | | | | IJ44, IJ45 |
| Extra | Where an actuator is | A simple solution | Not suitable where | May be used with: |
| power to | not normally driven to | where applicable | there is a hard limit | IJ03, IJ09, IJ16, |
| ink | the limit of its motion, | | to actuator | IJ20, IJ23, IJ24, |
| pushing | nozzle clearing may be | | movement | IJ25, IJ27, IJ29, |
| actuator | assisted by providing | | | IJ30, IJ31, IJ32, |
| | an enhanced drive | | | IJ39, IJ40, IJ41, |
| | signal to the actuator. | | | IJ42, IJ43, IJ44, |
| | | | | IJ45 |
| Acoustic | An ultrasonic wave is | A high nozzle | High | IJ08, IJ13, IJ15, |
| resonance | applied to the ink | clearing capability | implementation cost | IJ17, IJ18, IJ19, |
| | chamber. This wave is | can be achieved | if system does not | IJ21 |
| | of an appropriate | May be | already include an | |
| | amplitude and | implemented at very | acoustic actuator | |
| | frequency to cause | low cost in systems | | |
| | sufficient force at the | which already | | |
| | nozzle to clear | include acoustic | | |
| | blockages. This is | actuators | | |
| | easiest to achieve if | | | |
| | the ultrasonic wave is | | | |
| | at a resonant | | | |
| | frequency of the ink | | | |
| | cavity. | | | |
| Nozzle | A microfabricated | Can clear severely | Accurate | Silverbrook, EP |
| clearing | plate is pushed against | clogged nozzles | mechanical | 0771 658 A2 and |
| plate | the nozzles. The plate | | alignment is | related patent |
| | has a post for every | | required | applications |
| | nozzle. A post moves | | Moving parts are | |
| | through each nozzle, | | required | |
| | displacing dried ink. | | There is risk of | |
| | | | damage to the | |
| | | | nozzles | |
| | | | Accurate fabrication | |
| | | | is required | |
| Ink | The pressure of the ink | May be effective | Requires pressure | May be used with |
| pressure | is temporarily | where other | pump or other | all IJ series ink jets |
| pulse | increased so that ink | methods cannot be | pressure actuator | |
| | streams from all of the | used | Expensive | |
| | nozzles. This may be | | Wasteful of ink | |
| | used in conjunction | | | |
| | with actuator | | | |
| | energizing. | | | |
| Print head | A flexible ‘blade’ is | Effective for planar | Difficult to use if | Many ink jet |
| wiper | wiped across the print | print head surfaces | print head surface is | systems |
| | head surface. The | Low cost | non-planar or very | |
| | blade is usually | | fragile | |
| | fabricated from a | | Requires | |
| | flexible polymer, e.g. | | mechanical parts | |
| | rubber or synthetic | | Blade can wear out | |
| | elastomer. | | in high volume print | |
| | | | systems | |
| Separate | A separate heater is | Can be effective | Fabrication | Can be used with |
| ink biling | provided at the nozzle | where other nozzle | complexity | many IJ series ink |
| heater | although the normal | clearing methods | | jets |
| | drop e-ection | cannot be used | | |
| | mechanism does not | Can be implemented | | |
| | require it. The heaters | at no additional cost | | |
| | do not require | in some ink jet | | |
| | individual drive | configurations | | |
| | circuits, as many | | | |
| | nozzles can be cleared | | | |
| | simultaneously, and no | | | |
| | imaging is required. | | | |

NOZZLE PLATE CONSTRUCTION

| Nozzle plate | | | | |
|---|---|---|---|---|
| construction | Description | Advantages | Disadvantages | Examples |
| Electro- | A nozzle plate is | Fabrication | High temperatures | Hewlett Packard |
| formed | separately fabricated | simplicity | and pressures are | Thermal Ink jet |
| nickel | from electroformed | | required to bond | |
| | nickel, and bonded to | | nozzle plate | |
| | the print head chip. | | Minimum thickness | |
| | | | constraints | |
| | | | Differential thermal | |
| | | | expansion | |
| Laser | Individual nozzle | No masks required | Each hole must be | Canon Bubblejet |
| ablated or | holes are ablated by an | Can be quite fast | individually formed | 1988 Sercel et al., |
| drilled | intense UV laser in a | Some control over | Special equipment | SPIE, Vol. 998 |
| polymer | nozzle plate, which is | nozzle profile is | required | Excimer Beam |
| | typically a polymer | possible | Slow where there | Applications, pp. |
| | such as polyimide or | Equipment required | are many thousands | 76-83 |
| | polysulphone | is relatively low cost | of nozzles per print | 1993 Watanabe et |
| | | | head | al., USP 5,208,604 |
| | | | May produce thin | |
| | | | burrs at exit holes | |
| Silicon | A separate nozzle | High accuracy is | Two part | K. Bean, IEEE |
| micro- | plate is | attainable | construction | Transactions on |
| machined | micromachined from | | High cost | Electron Devices, |
| | single crystal silicon, | | Requires precision | Vol. ED-25, No. 10, |
| | and bonded to the | | alignment | 1978, pp 1185-1195 |
| | print head wafer. | | Nozzles may be | Xerox 1990 |
| | | | clogged by adhesive | Hawkins et al., USP |
| | | | | 4,899,181 |
| Glass | Fine glass capillaries | No expensive | Very small nozzle | 1970 Zoltan USP |
| capillaries | are drawn from glass | equipment required | sizes are difficult to | 3,683,212 |
| | tubing. This method | Simple to make | form | |
| | has been used for | single nozzles | Not suited for mass | |
| | making individual | | production | |
| | nozzles, but is difficult | | | |
| | to use for bulk | | | |
| | manufacturing of print | | | |
| | heads with thousands | | | |
| | of nozzles. | | | |
| Monolithic, | The nozzle plate is | High accuracy (<1 μm) | Requires sacrificial | Silverbrook, EP |
| surface | deposited as a layer | Monolithic | layer under the | 0771 658 A2 and |
| micro- | using standard VLSI | Low cost | nozzle plate to form | related patent |
| machined | deposition techniques. | Existing processes | the nozzle chamber | applications |
| using VLSI | Nozzles are etched in | can be used | Surface may be | IJ01, IJ02, IJ04, |
| lith — | the nozzle plate using | | fragile to the touch | IJ11, IJ12, IJ17, |
| graphic | VLSI lithography and | | | IJ18, IJ20, IJ22, |
| processes | etching. | | | IJ24, IJ27, IJ28, |
| | | | | IJ29, IJ30, IJ31, |
| | | | | IJ32, IJ33, IJ34, |
| | | | | IJ36, IJ37, IJ38, |
| | | | | IJ39, IJ40, IJ41, |
| | | | | IJ42, IJ43, IJ44 |
| Monolithic, | The nozzle plate is a | High accuracy (<1 μm) | Requires long etch | IJ03, IJ05, IJ06, |
| etched | buried etch stop in the | Monolithic | times | IJ07, IJ08, IJ09, |
| through | wafer. Nozzle | Low cost | Requires a support | IJ10, IJ13, IJ14, |
| substrate | chambers are etched in | No differential | wafer | IJ15, IJ16, IJ19, |
| | the front of the wafer, | expansion | | IJ21, IJ23, IJ25, |
| | and the wafer is | | | IJ26 |
| | thinned from the back | | | |
| | side. Nozzles are then | | | |
| | etched in the etch stop | | | |
| | layer. | | | |
| No nozzle | Various methods have | No nozzles to | Difficult to control | Ricoh 1995 Sekiya |
| plate | been tried to eliminate | become clogged | drop position | et al USP 5,412,413 |
| | the nozzles entirely, to | | accurately | 1993 Hadimioglu et |
| | prevent nozzle | | Crosstalk problems | al EUP 550,192 |
| | clogging. These | | | 1993 Elrod et al |
| | include thermal bubble | | | EUP 572,220 |
| | mechanisms and | | | |
| | acoustic lens | | | |
| | mechanisms | | | |
| Trough | Each drop ejector has | Reduced | Drop firing | IJ35 |
| | a trough through | manufacturing | direction is sensitive | |
| | which a paddle moves. | complexity | to wicking. | |
| | There is no nozzle | Monolithic | | |
| | plate. | | | |
| Nozzle slit | The elimination of | No nozzles to | Difficult to control | 1989 Saito et al |
| instead of | nozzle holes and | become clogged | drop position | USP 4,799,068 |
| individual | replacement by a slit | | accurately | |
| nozzles | encompassing many | | Crosstalk problems | |
| | actuator positions | | | |
| | reduces nozzle | | | |
| | clogging, but increases | | | |
| | crosstalk due to ink | | | |
| | surface waves | | | |

DROP EJECTION DIRECTION

| Ejection | | | | |
|---|---|---|---|---|
| direction | Description | Advantages | Disadvantages | Examples |
| Edge | Ink flow is along the | Simple construction | Nozzles limited to | Canon Bubblejet |
| (‘edge | surface of the chip, | No silicon etching | edge | 1979 Endo et al GB |
| shooter’) | and ink drops are | required | High resolution is | patent 2,007,162 |
| | ejected from the chip | Good heat sinking | difficult | Xerox heater-in-pit |
| | edge. | via substrate | Fast color printing | 1990 Hawkins et al |
| | | Mechanically strong | requires one print | USP 4,899,181 |
| | | Ease of chip | head per color | Tone-jet |
| | | handing | | |
| Surface | Ink flow is along the | No bulk silicon | Maximum ink flow | Hewlett-Packard TIJ |
| (‘roof | surface of the chip, | etching required | is severely restricted | 1982 Vaught et al |
| shooter’) | and ink drops are | Silicon can make an | | USP 4,490,728 |
| | ejected from the chip | effective heat sink | | IJ02, IJ11, IJ12, |
| | surface, normal to the | Mechanical strength | | IJ20, IJ22 |
| | plane of the chip. | | | |
| Through | Ink flow is through the | High ink flow | Requires bulk | Silverbrook, EP |
| chip, | chip, and ink drops are | Suitable for | silicon etching | 0771 658 A2 and |
| forward | ejected from the front | pagewidth print | | related patent |
| (‘up | surface of the chip. | heads | | applications |
| shooter’) | | High nozzle packing | | IJ04, IJ17, IJ18, |
| | | density therefore | | IJ24, IJ27-IJ45 |
| | | low manufacturing | | |
| | | cost | | |
| Through | Ink flow is through the | High ink flow | Requires wafer | IJ01, IJ03, IJ05, |
| chip, | chip, and ink drops are | Suitable for | thinning | IJ06, IJ07, IJ08, |
| r verse | ejected from the rear | pagewidth print | Requires special | IJ09,IJ10, IJ13, |
| (‘down | surface of the chip. | heads | handling during | IJ14, IJ15, IJ16, |
| shooter’) | | High nozzle packing | manufacture | IJ19, IJ21, IJ23, |
| | | density therefore | | IJ25, IJ26 |
| | | low manufacturing | | |
| | | cost | | |
| Through | Ink flow is through the | Suitable for | Pagewidth print | Epson Stylus |
| actuator | actuator, which is not | piezoelectric print | heads require | Tektronix hot melt |
| | fabricated as part of | heads | several thousand | piezoelectric ink jets |
| | the same substrate as | | connections to drive | |
| | the drive transistors. | | circuits | |
| | | | Cannot be | |
| | | | manufactured in | |
| | | | standard CMOS | |
| | | | fabs | |
| | | | Complex assembly | |
| | | | required | |

INK TYPE

| Ink | | | | |
|---|---|---|---|---|
| type | Description | Advantages | Disadvantages | Examples |
| Aqueous, | Water based ink which | Environmentally | Slow drying | Most existing ink |
| dye | typically contains: | friendly | Corrosive | jets |
| | water, dye, surfactant, | No odor | Bleeds on paper | All IJ series ink jets |
| | humectant, and | | May strikethrough | Silverbrook, EP |
| | biocide. | | Cockles paper | 0771 658 A2 and |
| | Modern ink dyes have | | | related patent |
| | high water-fastness, | | | applications |
| | light fastness | | | |
| Aqueous, | Water based ink which | Environmentally | Slow drying | IJ02, IJ04, IJ21, |
| pigment | typically contains: | friendly | Corrosive | IJ26, IJ27, IJ30 |
| | water, pigment, | No odor | Pigment may clog | Silverbrook, EP |
| | surfactant, humectant, | Reduced bleed | nozzles | 0771 658 A2 and |
| | and biocide. | Reduced wicking | Pigment may clog | related patent |
| | Pigments have an | Reduced | actuator | applications |
| | advantage in reduced | strikethrough | mechanisms | Piezoelectric ink- |
| | bleed, wicking and | | Cockles paper | jets |
| | strikethrough. | | | Thermal ink jets |
| | | | | (with significant |
| | | | | restrictions) |
| Methyl | MEK is a highly | Very fast drying | Odorous | All IJ series ink jets |
| Ethyl | volatile solvent used | Prints on various | Flammable | |
| Ketone | for industrial printing | substrates such as | | |
| (MEK) | on difficult surfaces | metals and plastics | | |
| | such as aluminum | | | |
| | cans. | | | |
| Alc hol | Alcohol based inks | Fast drying | Slight odor | All IJ series ink jets |
| (ethanol, | can be used where the | Operates at sub- | Flammable | |
| 2-butanol, | printer must operate at | freezing | | |
| and | temperatures below | temperatures | | |
| others) | the freezing point of | Reduced paper | | |
| | water. An example of | cockle | | |
| | this is in-camera | Low cost | | |
| | consumer | | | |
| | photographic printing. | | | |
| Phase | The ink is solid at | No drying time- ink | High viscosity | Tektronix hot melt |
| change | room temperature, and | instantly freezes on | Printed ink typically | piezoelectric ink jets |
| (hot melt) | is melted in the print | the print medium | has a ‘waxy’ feel | 1989 Nowak USP |
| | head before jetting. | Almost any print | Printed pages may | 4,820,346 |
| | Hot melt inks are | medium can be used | ‘block’ | All IJ series ink jets |
| | usually wax based, | No paper cockle | Ink temperature | |
| | with a melting point | occurs | may be above the | |
| | around 80° C. After | No wicking occurs | curie point of | |
| | jetting the ink freezes | No bleed occurs | permanent magnets | |
| | almost instantly upon | No strikethrough | Ink heaters consume | |
| | contacting the print | occurs | power | |
| | medium or a transfer | | Long warm-up time | |
| | roller. | | | |
| Oil | Oil based inks are | High solubility | High viscosity: this | All IJ series ink jets |
| | extensively used in | medium for some | is a significant | |
| | offset printing. They | dyes | limitation for use in | |
| | have advantages in | Does not cockle | ink jets, which | |
| | improved | paper | usually require a | |
| | characteristics on | Does not wick | low viscosity. Some | |
| | paper (especially no | through paper | short chain and | |
| | wicking or cockle). | | multi-branched oils | |
| | Oil soluble dies and | | have a sufficiently | |
| | pigments are required. | | low viscosity. | |
| | | | Slow drying | |
| Micro- | A microemulsion is a | Stops ink bleed | Viscosity higher | All IJ series ink jets |
| emulsion | stable, self forming | High dye solubility | than water | |
| | emulsion of oil, water, | Water, oil, and | Cost is slightly | |
| | and surfactant. The | amphiphilic soluble | higher than water | |
| | characteristic drop size | dies can be used | based ink | |
| | is less than 100 nm, | Can stabilize | High surfactant | |
| | and is determined by | pigment | concentration | |
| | the preferred curvature | suspensions | required (around | |
| | of the surfactant. | | 5%) | |

### Ink Jet Printing

A large number of new forms of ink jet printers have been developed to facilitate alternative ink jet technologies for the image processing and data distribution system. Various combinations of ink jet devices can be included in printer devices incorporated as part of the present invention. Australian Provisional Patent Applications relating to these ink jets which are specifically incorporated by cross reference. The serial numbers of respective corresponding US patent applications are also provided for the sake of convenience.

| Australian | | | US Patent/Patent |
|---|---|---|---|
| Provisional | | | Application and |
| Number | Filing Date | Title | Filing Date |
| PO8066 | 15 Jul. 1997 | Image Creation | 6,227,652 |
| | | Method and Apparatus | (Jul. 10, 1998) |
| | | (IJ01) | |
| PO8072 | 15 Jul. 1997 | Image Creation | 6,213,588 |
| | | Method and Apparatus | (Jul. 10, 1998) |
| | | (IJ02) | |
| PO8040 | 15 Jul. 1997 | Image Creation | 6,213,589 |
| | | Method and Apparatus | (Jul. 10, 1998) |
| | | (IJ03) | |
| PO8071 | 15 Jul. 1997 | Image Creation | 6,231,163 |
| | | Method and Apparatus | (Jul. 10, 1998) |
| | | (IJ04) | |
| PO8047 | 15 Jul. 1997 | Image Creation | 6,247,795 |
| | | Method and Apparatus | (Jul. 10, 1998) |
| | | (IJ05) | |
| PO8035 | 15 Jul. 1997 | Image Creation | 6,394,581 |
| | | Method and Apparatus | (Jul. 10, 1998) |
| | | (IJ06) | |
| PO8044 | 15 Jul. 1997 | Image Creation | 6,244,691 |
| | | Method and Apparatus | (Jul. 10, 1998) |
| | | (IJ07) | |
| PO8063 | 15 Jul. 1997 | Image Creation | 6,257,704 |
| | | Method and Apparatus | (Jul. 10, 1998) |
| | | (IJ08) | |
| PO8057 | 15 Jul. 1997 | Image Creation | 6,416,168 |
| | | Method and Apparatus | (Jul. 10, 1998) |
| | | (IJ09) | |
| PO8056 | 15 Jul. 1997 | Image Creation | 6,220,694 |
| | | Method and Apparatus | (Jul. 10, 1998) |
| | | (IJ10) | |
| PO8069 | 15 Jul. 1997 | Image Creation | 6,257,705 |
| | | Method and Apparatus | (Jul. 10, 1998) |
| | | (IJ11) | |
| PO8049 | 15 Jul. 1997 | Image Creation | 6,247,794 |
| | | Method and Apparatus | (Jul. 10, 1998) |
| | | (IJ12) | |
| PO8036 | 15 Jul. 1997 | Image Creation | 6,234,610 |
| | | Method and Apparatus | (Jul. 10, 1998) |
| | | (IJ13) | |
| PO8048 | 15 Jul. 1997 | Image Creation | 6,247,793 |
| | | Method and Apparatus | (Jul. 10, 1998) |
| | | (IJ14) | |
| PO8070 | 15 Jul. 1997 | Image Creation | 6,264,306 |
| | | Method and Apparatus | (Jul. 10, 1998) |
| | | (IJ15) | |
| PO8067 | 15 Jul. 1997 | Image Creation | 6,241,342 |
| | | Method and Apparatus | (Jul. 10, 1998) |
| | | (IJ16) | |
| PO8001 | 15 Jul. 1997 | Image Creation | 6,247,792 |
| | | Method and Apparatus | (Jul. 10, 1998) |
| | | (IJ17) | |
| PO8038 | 15 Jul. 1997 | Image Creation | 6,264,307 |
| | | Method and Apparatus | (Jul. 10, 1998) |
| | | (IJ18) | |
| PO8033 | 15 Jul. 1997 | Image Creation | 6,254,220 |
| | | Method and Apparatus | (Jul. 10, 1998) |
| | | (IJ19) | |
| PO8002 | 15 Jul. 1997 | Image Creation | 6,234,611 |
| | | Method and Apparatus | (Jul. 10, 1998) |
| | | (IJ20) | |
| PO8068 | 15 Jul. 1997 | Image Creation | 6,302,528 |
| | | Method and Apparatus | (Jul. 10, 1998) |
| | | (IJ21) | |
| PO8062 | 15 Jul. 1997 | Image Creation | 6,283,582 |
| | | Method and Apparatus | (Jul. 10, 1998) |
| | | (IJ22) | |
| PO8034 | 15 Jul. 1997 | Image Creation | 6,239,821 |
| | | Method and Apparatus | (Jul. 10, 1998) |
| | | (IJ23) | |
| PO8039 | 15 Jul. 1997 | Image Creation | 6,338,547 |
| | | Method and Apparatus | (Jul. 10, 1998) |
| | | (IJ24) | |
| PO8041 | 15 Jul. 1997 | Image Creation | 6,247,796 |
| | | Method and Apparatus | (Jul. 10, 1998) |
| | | (IJ25) | |
| PO8004 | 15 Jul. 1997 | Image Creation | 09/113,122 |
| | | Method and Apparatus | (Jul. 10, 1998) |
| | | (IJ26) | |
| PO8037 | 15 Jul. 1997 | Image Creation | 6,390,603 |
| | | Method and Apparatus | (Jul. 10, 1998) |
| | | (IJ27) | |
| PO8043 | 15 Jul. 1997 | Image Creation | 6,362,843 |
| | | Method and Apparatus | (Jul. 10, 1998) |
| | | (IJ28) | |
| PO8042 | 15 Jul. 1997 | Image Creation | 6,293,653 |
| | | Method and Apparatus | (Jul. 10, 1998) |
| | | (IJ29) | |
| PO8064 | 15 Jul. 1997 | Image Creation | 6,312,107 |
| | | Method and Apparatus | (Jul. 10, 1998) |
| | | (IJ30) | |
| PO9389 | 23 Sep. 1997 | Image Creation | 6,227,653 |
| | | Method and Apparatus | (Jul. 10, 1998) |
| | | (IJ31) | |
| PO9391 | 23 Sep. 1997 | Image Creation | 6,234,609 |
| | | Method and Apparatus | (Jul. 10, 1998) |
| | | (IJ32) | |
| PP0888 | 12 Dec. 1997 | Image Creation | 6,238,040 |
| | | Method and Apparatus | (Jul. 10, 1998) |
| | | (IJ33) | |
| PP0891 | 12 Dec. 1997 | Image Creation | 6,188,415 |
| | | Method and Apparatus | (Jul. 10, 1998) |
| | | (IJ34) | |
| PP0890 | 12 Dec. 1997 | Image Creation | 6,227,654 |
| | | Method and Apparatus | (Jul. 10, 1998) |
| | | (IJ35) | |
| PP0873 | 12 Dec. 1997 | Image Creation | 6,209,989 |
| | | Method and Apparatus | (Jul. 10, 1998) |
| | | (IJ36) | |
| PP0993 | 12 Dec. 1997 | Image Creation | 6,247,791 |
| | | Method and Apparatus | Jul. 10, 1998) |
| | | (IJ37) | |
| PP0890 | 12 Dec. 1997 | Image Creation | 6,336,710 |
| | | Method and Apparatus | (Jul. 10, 1998) |
| | | (IJ38) | |
| PP1398 | 19 Jan. 1998 | An Image Creation | 6,217,153 |
| | | Method and Apparatus | (Jul. 10, 1998) |
| | | (IJ39) | |
| PP2592 | 25 Mar. 1998 | An Image Creation | 6,416,167 |
| | | Method and Apparatus | (Jul. 10, 1998) |
| | | (IJ40) | |
| PP2593 | 25 Mar. 1998 | Image Creation | 6,243,113 |
| | | Method and Apparatus | (Jul. 10, 1998) |
| | | (IJ41) | |
| PP3991 | 9 Jun. 1998 | Image Creation | 6,283,581 |
| | | Method and Apparatus | (Jul. 10, 1998) |
| | | (IJ42) | |
| PP3987 | 9 Jun. 1998 | Image Creation | 6,247,790 |
| | | Method and Apparatus | (Jul. 10, 1998) |
| | | (IJ43) | |
| PP3985 | 9 Jun. 1998 | Image Creation | 6,260,953 |
| | | Method and Apparatus | (Jul. 10, 1998) |
| | | (IJ44) | |
| PP3983 | 9 Jun. 1998 | Image Creation | 6,267,469 |
| | | Method and Apparatus | (Jul. 10, 1998) |
| | | (IJ45) | |

Ink Jet Manufacturing

Further, the present application may utilize advanced semiconductor fabrication techniques in the construction of large arrays of ink jet printers. Suitable manufacturing techniques are described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application and |
| Number | Filing Date | Title | Filing Date |
| PO7935 | 15 Jul. 1997 | A Method of | 6,224,780 |
| | | Manufacture | (Jul. 10, 1998) |
| | | of an Image | |
| | | Creation | |
| | | Apparatus | |
| | | (IJM01) | |
| PO7936 | 15 Jul. 1997 | A Method of | 6,235,212 |
| | | Manufacture | (Jul. 10, 1998) |
| | | of an Image | |
| | | Creation | |
| | | Apparatus | |
| | | (IJM02) | |
| PO7937 | 15 Jul. 1997 | A Method of | 6,280,643 |
| | | Manufacture | (Jul. 10, 1998) |
| | | of an Image | |
| | | Creation | |
| | | Apparatus | |
| | | (IJM03) | |
| PO8061 | 15 Jul. 1997 | A Method of | 6,284,147 |
| | | Manufacture | (Jul. 10, 1998) |
| | | of an Image | |
| | | Creation | |
| | | Apparatus | |
| | | (IJM04) | |
| PO8054 | 15 Jul. 1997 | A Method of | 6,214,244 |
| | | Manufacture | (Jul. 10, 1998) |
| | | of an Image | |
| | | Creation | |
| | | Apparatus | |
| | | (IJM05) | |
| PO8065 | 15 Jul. 1997 | A Method of | 6,071,750 |
| | | Manufacture | (Jul. 10, 1998) |
| | | of an Image | |
| | | Creation | |
| | | Apparatus | |
| | | (IJM06) | |
| PO8055 | 15 Jul. 1997 | A Method of | 6,267,905 |
| | | Manufacture | (Jul. 10, 1998) |
| | | of an Image | |
| | | Creation | |
| | | Apparatus | |
| | | (IJM07) | |
| PO8053 | 15 Jul. 1997 | A Method of | 6,251,298 |
| | | Manufacture | (Jul. 10, 1998) |
| | | of an Image | |
| | | Creation | |
| | | Apparatus | |
| | | (IJM08) | |
| PO8078 | 15 Jul. 1997 | A Method of | 6,258,285 |
| | | Manufacture | (Jul. 10, 1998) |
| | | of an Image | |
| | | Creation | |
| | | Apparatus | |
| | | (IJM09) | |
| PO7933 | 15 Jul. 1997 | A Method of | 6,225,138 |
| | | Manufacture | (Jul. 10, 1998) |
| | | of an Image | |
| | | Creation | |
| | | Apparatus | |
| | | IJM10) | |
| PO7950 | 15 Jul. 1997 | A Method of | 6,241,904 |
| | | Manufacture | (Jul. 10, 1998) |
| | | of an Image | |
| | | Creation | |
| | | Apparatus | |
| | | (IJM11) | |
| PO7949 | 15 Jul. 1997 | A Method of | 6,299,786 |
| | | Manufacture | (Jul. 10, 1998) |
| | | of an Image | |
| | | Creation | |
| | | Apparatus | |
| | | (IJM12) | |
| PO8060 | 15 Jul. 1997 | A Method of | 09/113,124 |
| | | Manufacture | (Jul. 10, 1998) |
| | | of an Image | |
| | | Creation | |
| | | Apparatus | |
| | | (IJM13) | |
| PO8059 | 15 Jul. 1997 | A Method of | 6,231,773 |
| | | Manufacture | (Jul. 10, 1998) |
| | | of an Image | |
| | | Creation | |
| | | Apparatus | |
| | | (IJM14) | |
| PO8073 | 15 Jul. 1997 | A Method of | 6,190,931 |
| | | Manufacture | (Jul. 10, 1998) |
| | | of an Image | |
| | | Creation | |
| | | Apparatus | |
| | | (IJM15) | |
| PO8076 | 15 Jul. 1997 | A Method of | 6,248,249 |
| | | Manufacture | (Jul. 10, 1998) |
| | | of an Image | |
| | | Creation | |
| | | Apparatus | |
| | | (IJM16) | |
| PO8075 | 15 Jul. 1997 | A Method of | 6,290,862 |
| | | Manufacture | (Jul. 10, 1998) |
| | | of an Image | |
| | | Creation | |
| | | Apparatus | |
| | | (IJM17) | |
| PO8079 | 15 Jul. 1997 | A Method of | 6,241,906 |
| | | Manufacture | (Jul. 10, 1998) |
| | | of an Image | |
| | | Creation | |
| | | Apparatus | |
| | | (IJM18) | |
| PO8050 | 15 Jul. 1997 | A Method of | 09/113,116 |
| | | Manufacture | (Jul. 10, 1998) |
| | | of an Image | |
| | | Creation | |
| | | Apparatus | |
| | | (IJM19) | |
| PO8052 | 15 Jul. 1997 | A Method of | 6,241,905 |
| | | Manufacture | (Jul. 10, 1998) |
| | | of an Image | |
| | | Creation | |
| | | Apparatus | |
| | | (IJM20) | |
| PO7948 | 15 Jul. 1997 | A Method of | 6,451,216 |
| | | Manufacture | (Jul. 10, 1998) |
| | | of an Image | |
| | | Creation | |
| | | Apparatus | |
| | | (IJM21) | |
| PO7951 | 15 Jul. 1997 | A Method of | 6,231,772 |
| | | Manufacture | (Jul. 10, 1998) |
| | | of an Image | |
| | | Creation | |
| | | Apparatus | |
| | | (IJM22) | |
| PO8074 | 15 Jul. 1997 | A Method of | 6,274,056 |
| | | Manufacture | (Jul. 10, 1998) |
| | | of an Image | |
| | | Creation | |
| | | Apparatus | |
| | | (IJM23) | |
| PO7941 | 15 Jul. 1997 | A Method of | 6,290,861 |
| | | Manufacture | (Jul. 10, 1998) |
| | | of an Image | |
| | | Creation | |
| | | Apparatus | |
| | | (IJM24) | |
| PO8077 | 15 Jul. 1997 | A Method of | 6,248,248 |
| | | Manufacture | (Jul. 10, 1998) |
| | | of an Image | |
| | | Creation | |
| | | Apparatus | |
| | | (IJM25) | |
| PO8058 | 15 Jul. 1997 | A Method of | 6,306,671 |
| | | Manufacture | (Jul. 10, 1998) |
| | | of an Image | |
| | | Creation | |
| | | Apparatus | |
| | | (IJM26) | |
| PO8051 | 15 Jul. 1997 | A Method of | 6,331,258 |
| | | Manufacture | (Jul. 10, 1998) |
| | | of an Image | |
| | | Creation | |
| | | Apparatus | |
| | | (IJM27) | |
| PO8045 | 15 Jul. 1997 | A Method of | 6,110,754 |
| | | Manufacture | (Jul. 10, 1998) |
| | | of an Image | |
| | | Creation | |
| | | Apparatus | |
| | | (IJM28) | |
| PO7952 | 15 Jul. 1997 | A Method of | 6,294,101 |
| | | Manufacture | (Jul. 10, 1998) |
| | | of an Image | |
| | | Creation | |
| | | Apparatus | |
| | | (IJM29) | |
| PO8046 | 15 Jul. 1997 | A Method of | 6,416,679 |
| | | Manufacture | (Jul. 10, 1998) |
| | | of an Image | |
| | | Creation | |
| | | Apparatus | |
| | | (IJM30) | |
| PO8503 | 11 Aug. 1997 | A Method of | 6,264,849 |
| | | Manufacture | (Jul. 10, 1998) |
| | | of an Image | |
| | | Creation | |
| | | Apparatus | |
| | | (IJM30a) | |
| PO9390 | 23 Sep. 1997 | A Method of | 6,254,793 |
| | | Manufacture | (Jul. 10, 1998) |
| | | of an Image | |
| | | Creation | |
| | | Apparatus | |
| | | (IJM31) | |
| PO9392 | 23 Sep. 1997 | A Method of | 6,235,211 |
| | | Manufacture | (Jul. 10, 1998) |
| | | of an Image | |
| | | Creation | |
| | | Apparatus | |
| | | (IJM32) | |
| PP0889 | 12 Dec. 1997 | A Method of | 6,235,211 |
| | | Manufacture | (Jul. 10, 1998) |
| | | of an Image | |
| | | Creation | |
| | | Apparatus | |
| | | (IJM35) | |
| PP0887 | 12 Dec. 1997 | A Method of | 6,264,850 |
| | | Manufacture | (Jul. 10, 1998) |
| | | of an Image | |
| | | Creation | |
| | | Apparatus | |
| | | (IJM36) | |
| PP0882 | 12 Dec. 1997 | A Method of | 6,258,284 |
| | | Manufacture | (Jul. 10, 1998) |
| | | of an Image | |
| | | Creation | |
| | | Apparatus | |
| | | (IJM37) | |
| PP0874 | 12 Dec. 1997 | A Method of | 6,258,284 |
| | | Manufacture | (Jul. 10, 1998) |
| | | of an Image | |
| | | Creation | |
| | | Apparatus | |
| | | (IJM38) | |
| PP1396 | 19 Jan. 1998 | A Method of | 6,228,668 |
| | | Manufacture | (Jul. 10, 1998) |
| | | of an Image | |
| | | Creation | |
| | | Apparatus | |
| | | (IJM39) | |
| PP2591 | 25 Mar. 1998 | A Method of | 6,180,427 |
| | | Manufacture | (Jul. 10, 1998) |
| | | of an Image | |
| | | Creation | |
| | | Apparatus | |
| | | (IJM41) | |
| PP3989 | 9 Jun. 1998 | A Method of | 6,171,875 |
| | | Manufacture | (Jul. 10, 1998) |
| | | of an Image | |
| | | Creation | |
| | | Apparatus | |
| | | (IJM40) | |
| PP3990 | 9 Jun. 1998 | A Method of | 6,267,904 |
| | | Manufacture | (Jul. 10, 1998) |
| | | of an Image | |
| | | Creation | |
| | | Apparatus | |
| | | (IJM42) | |
| PP3986 | 9 Jun. 1998 | A Method of | 6,245,247 |
| | | Manufacture | (Jul. 10, 1998) |
| | | of an Image | |
| | | Creation | |
| | | Apparatus | |
| | | (IJM43) | |
| PP3984 | 9 Jun. 1998 | A Method of | 6,245,247 |
| | | Manufacture | (Jul. 10, 1998) |
| | | of an Image | |
| | | Creation | |
| | | Apparatus | |
| | | (IJM44) | |
| PP3982 | 9 Jun. 1998 | A Method of | 6,231,148 |
| | | Manufacture | (Jul. 10, 1998) |
| | | of an Image | |
| | | Creation | |
| | | Apparatus | |
| | | (IJM45) | |

### Fluid Supply

Further, the present application may utilize an ink delivery system to the ink jet head. Delivery systems relating to the supply of ink to a series of ink jet nozzles are described in the following Australian provisional patent specifications, the disclosure of which are hereby incorporated by cross-reference. The serial numbers of respective corresponding US patent applications are also provided for the sake of convenience.

| Australian | | | US Patent/Patent |
|---|---|---|---|
| Provisional | | | Application |
| Number | Filing Date | Title | and Filing Date |
| PO8003 | 15 Jul. 1997 | Supply Method | 6,350,023 |
| | | and Apparatus (F1) | (Jul. 10, 1998) |
| PO8005 | 15 Jul. 1997 | Supply Method | 6,318,849 |
| | | and Apparatus (F2) | (Jul. 10, 1998) |
| PO9404 | 23 Sep. 1997 | A Device and | 09/113,101 |
| | | Method (F3) | (Jul. 10, 1998) |

### MEMS Technology

Further, the present application may utilize advanced semiconductor microelectromechanical techniques in the construction of large arrays of ink jet printers. Suitable microelectromechanical techniques are described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application |
| Number | Filing Date | Title | and Filing Date |
| PO7943 | 15 Jul. 1997 | A device (MEMS01) | |
| PO8006 | 15 Jul. 1997 | A device (MEMS02) | 6,087,638 |
| | | | (Jul. 10, 1998) |
| PO8007 | 15 Jul. 1997 | A device (MEMS03) | 09/113,093 |
| | | | (Jul. 10, 1998) |
| PO8008 | 15 Jul. 1997 | A device (MEMS04) | 6,340,222 |
| | | | (Jul. 10, 1998) |
| PO8010 | 15 Jul. 1997 | A device (MEMS05) | 6,041,600 |
| | | | (Jul. 10, 1998) |
| PO8011 | 15 Jul. 1997 | A device (MEMS06) | 6,299,300 |
| | | | (Jul. 10, 1998) |
| PO7947 | 15 Jul. 1997 | A device (MEMS07) | 6,067,797 |
| | | | (Jul. 10, 1998) |
| PO7945 | 15 Jul. 1997 | A device (MEMS08) | 09/113,081 |
| | | | (Jul. 10, 1998) |
| PO7944 | 15 Jul. 1997 | A device (MEMS09) | 6,286,935 |
| | | | (Jul. 10, 1998) |
| PO7946 | 15 Jul. 1997 | A device (MEMS10) | 6,044,646 |
| | | | (Jul. 10, 1998) |
| PO9393 | 23 Sep. 1997 | A Device and | 09/113,065 |
| | | Method (MEMS11) | (Jul. 10, 1998) |
| PP0875 | 12 Dec. 1997 | A Device (MEMS12) | 09/113,078 |
| | | | (Jul. 10, 1998) |
| PP0894 | 12 Dec. 1997 | A Device and | 09/113,075 |
| | | Method (MEMS13) | (Jul. 10, 1998) |

### IR Technologies

Further, the present application may include the utilization of a disposable camera system such as those described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application |
| Number | Filing Date | Title | and Filing Date |
| PP0895 | 12 Dec. 1997 | An Image Creation | 6,231,148 |
| | | Method and | (Jul. 10, 1998) |
| | | Apparatus (IR01) | |
| PP0870 | 12 Dec. 1997 | A Device and | 09/113,106 |
| | | Method (IR02) | (Jul. 10, 1998) |
| PP0869 | 12 Dec. 1997 | A Device and | 6,293,658 |
| | | Method (IR04) | (Jul. 10, 1998) |
| PP0887 | 12 Dec. 1997 | Image Creation | 09/113,104 |
| | | Method and | (Jul. 10, 1998) |
| | | Apparatus (IR05) | |
| PP0885 | 12 Dec. 1997 | An Image | 6,238,033 |
| | | Production | (Jul. 10, 1998) |
| | | System (IR06) | |
| PP0884 | 12 Dec. 1997 | Image Creation | 6,312,070 |
| | | Method and | (Jul. 10, 1998) |
| | | Apparatus (IR10) | |
| PP0886 | 12 Dec. 1997 | Image Creation | 6,238,111 |
| | | Method and | (Jul. 10, 1998) |
| | | Apparatus (IR12) | |
| PP0871 | 12 Dec. 1997 | A Device and | 09/113,086 |
| | | Method (IR13) | (Jul. 10, 1998) |
| PP0876 | 12 Dec. 1997 | An Image | 09/113,094 |
| | | Processing | (Jul. 10, 1998) |
| | | Method and | |
| | | Apparatus (IR14) | |
| PP0877 | 12 Dec. 1997 | A Device and | 6,378,970 |
| | | Method (IR16) | (Jul. 10, 1998) |
| PP0878 | 12 Dec. 1997 | A Device and | 6,196,739 |
| | | Method (IR17) | (Jul. 10, 1998) |
| PP0879 | 12 Dec. 1997 | A Device and | 09/112,774 |
| | | Method (IR18) | (Jul. 10, 1998) |
| PP0883 | 12 Dec. 1997 | A Device and | 6,270,182 |
| | | Method (IR19) | (Jul. 10, 1998) |
| PP0880 | 12 Dec. 1997 | A Device and | 6,152,619 |
| | | Method (IR20) | (Jul. 10, 1998) |
| PP0881 | 12 Dec. 1997 | A Device and | 09/113,092 |
| | | Method (IR21) | (Jul. 10, 1998) |

DotCard Technologies

Further, the present application may include the utilization of a data distribution system such as that described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application |
| Number | Filing Date | Title | and Filing Date |
| PP2370 | 16 Mar. 1998 | Data Processing | 09/112,781 |
| | | Method and | (Jul. 10, 1998) |
| | | Apparatus (Dot01) | |
| PP2371 | 16 Mar. 1998 | Data Processing | 09/113,052 |
| | | Method and | (Jul. 10, 1998) |
| | | Apparatus (Dot02) | |

### Artcam Technologies

Further, the present application may include the utilization of camera and data processing techniques such as an Artcam type device as described in the following Australian provisional patent specifications incorporated here by cross-reference. The serial numbers of respective corresponding US patent applications are also provided for the sake of convenience.

| Australian | | | US Patent/Patent |
|---|---|---|---|
| Provisional | | | Application |
| Number | Filing Date | Title | and Filing Date |
| PO7991 | 15 Jul. 1997 | Image Processing | 09/113,060 |
| | | Method and | (Jul. 10, 1998) |
| | | Apparatus | |
| | | (ART01) | |
| PO7988 | 15 Jul. 1997 | Image Processing | 6,476,863 |
| | | Method and | (Jul. 10, 1998) |
| | | Apparatus | |
| | | (ART02) | |
| PO7993 | 15 Jul. 1997 | Image Processing | 09/113,073 |
| | | Method and | (Jul. 10, 1998) |
| | | Apparatus | |
| | | (ART03) | |
| PO9395 | 23 Sep. 1997 | Data Processing | 6,322,181 |
| | | Method and | (Jul. 10, 1998) |
| | | Apparatus | |
| | | (ART04) | |
| PO8017 | 15 Jul. 1997 | Image Processing | 09/112,747 |
| | | Method and | (Jul. 10, 1998) |
| | | Apparatus | |
| | | (ART06) | |
| PO8014 | 15 Jul. 1997 | Media Device | 6,227,648 |
| | | (ART07) | (Jul. 10, 1998) |
| PO8025 | 15 Jul. 1997 | Image Processing | 09/112,750 |
| | | Method and | (Jul. 10, 1998) |
| | | Apparatus | |
| | | (ART08) | |
| PO8032 | 15 Jul. 1997 | Image Processing | 09/112,746 |
| | | Method and | (Jul. 10, 1998) |
| | | Apparatus | |
| | | (ART09) | |
| PO7999 | 15 Jul. 1997 | Image Processing | 09/112,743 |
| | | Method and | (Jul. 10, 1998) |
| | | Apparatus | |
| | | (ART10) | |
| PO7998 | 15 Jul. 1997 | Image Processing | 09/112,742 |
| | | Method and | (Jul. 10, 1998) |
| | | Apparatus | |
| | | (ART11) | |
| PO8031 | 15 Jul. 1997 | Image Processing | 09/112,741 |
| | | Method and | (Jul. 10, 1998) |
| | | Apparatus | |
| | | (ART12) | |
| PO8030 | 15 Jul. 1997 | Media Device | 6,196,541 |
| | | (ART13) | (Jul. 10, 1998) |
| PO7997 | 15 Jul. 1997 | Media Device | 6,195,150 |
| | | (ART15) | (Jul. 10, 1998) |
| PO7979 | 15 Jul. 1997 | Media Device | 6,362,868 |
| | | (ART16) | (Jul. 10, 1998) |
| PO8015 | 15 Jul. 1997 | Media Device | 09/112,738 |
| | | (ART17) | (Jul. 10, 1998) |
| PO7978 | 15 Jul. 1997 | Media Device | 09/113,067 |
| | | (ART18) | (Jul. 10, 1998) |
| PO7982 | 15 Jul. 1997 | Data Processing | 6,431,669 |
| | | Method and | (Jul. 10, 1998) |
| | | Apparatus | |
| | | (ART19) | |
| PO7989 | 15 Jul. 1997 | Data Processing | 6,362,869 |
| | | Method and | (Jul. 10, 1998) |
| | | Apparatus | |
| | | (ART20) | |
| PO8019 | 15 Jul. 1997 | Media Processing | 6,472,052 |
| | | Method and | (Jul. 10, 1998) |
| | | Apparatus | |
| | | (ART21) | |
| PO7980 | 15 Jul. 1997 | Image Processing | 6,356,715 |
| | | Method and | (Jul. 10, 1998) |
| | | Apparatus | |
| | | (ART22) | |
| PO8018 | 15 Jul. 1997 | Image Processing | 09/112,777 |
| | | Method and | (Jul. 10, 1998) |
| | | Apparatus | |
| | | (ART24) | |
| PO7938 | 15 Jul. 1997 | Image Processing | 09/113,224 |
| | | Method and | (Jul. 10, 1998) |
| | | Apparatus | |
| | | (ART25) | |
| PO8016 | 15 Jul. 1997 | Image Processing | 6,366,693 |
| | | Method and | (Jul. 10, 1998) |
| | | Apparatus | |
| | | (ART26) | |
| PO8024 | 15 Jul. 1997 | Image Processing | 6,329,990 |
| | | Method and | (Jul. 10, 1998) |
| | | Apparatus | |
| | | (ART27) | |
| PO7940 | 15 Jul. 1997 | Data Processing | 09/113,072 |
| | | Method and | (Jul. 10, 1998) |
| | | Apparatus | |
| | | (ART28) | |
| PO7939 | 15 Jul. 1997 | Data Processing | 09/112,785 |
| | | Method and | (Jul. 10, 1998) |
| | | Apparatus | |
| | | (ART29) | |
| PO8501 | 11 Aug. 1997 | Image Processing | 6,137,500 |
| | | Method and | (Jul. 10, 1998) |
| | | Apparatus | |
| | | (ART30) | |
| PO8500 | 11 Aug. 1997 | Image Processing | 09/112,796 |
| | | Method and | (Jul. 10, 1998) |
| | | Apparatus | |
| | | (ART31) | |
| PO7987 | 15 Jul. 1997 | Data Processing | 09/113,071 |
| | | Method and | (Jul. 10, 1998) |
| | | Apparatus | |
| | | (ART32) | |
| PO8022 | 15 Jul. 1997 | Image Processing | 6,398,328 |
| | | Method and | (Jul. 10, 1998) |
| | | Apparatus | |
| | | (ART33) | |
| PO8497 | 11 Aug. 1997 | Image Processing | 09/113,090 |
| | | Method and | (Jul. 10, 1998) |
| | | Apparatus | |
| | | (ART34) | |
| PO8020 | 15 Jul. 1997 | Data Processing | 6,431,704 |
| | | Method and | (Jul. 10, 1998) |
| | | Apparatus | |
| | | (ART38) | |
| PO8023 | 15 Jul. 1997 | Data Processing | 09/113,222 |
| | | Method and | (Jul. 10, 1998) |
| | | Apparatus | |
| | | (ART39) | |
| PO8504 | 11 Aug. 1997 | Image Processing | 09/112,786 |
| | | Method and | (Jul. 10, 1998) |
| | | Apparatus | |
| | | (ART42) | |
| PO8000 | 15 Jul. 1997 | Data Processing | 6,415,054 |
| | | Method and | (Jul. 10, 1998) |
| | | Apparatus | |
| | | (ART43) | |
| PO7977 | 15 Jul. 1997 | Data Processing | 09/112,782 |
| | | Method and | (Jul. 10, 1998) |
| | | Apparatus | |
| | | (ART44) | |
| PO7934 | 15 Jul. 1997 | Data Processing | 09/113,056 |
| | | Method and | (Jul. 10, 1998) |
| | | Apparatus | |
| | | (ART45) | |
| PO7990 | 15 Jul. 1997 | Data Processing | 09/113,059 |
| | | Method and | (Jul. 10, 1998) |
| | | Apparatus | |
| | | (ART46) | |
| PO8499 | 11 Aug. 1997 | Image Processing | 6,486,886 |
| | | Method and | (Jul. 10, 1998) |
| | | Apparatus | |
| | | (ART47) | |
| PO8502 | 11 Aug. 1997 | Image Processing | 6,381,361 |
| | | Method and | (Jul. 10, 1998) |
| | | Apparatus | |
| | | (ART48) | |
| PO7981 | 15 Jul. 1997 | Data Processing | 6,317,192 |
| | | Method and | (Jul. 10, 1998) |
| | | Apparatus | |
| | | (ART50) | |
| PO7986 | 15 Jul. 1997 | Data Processing | 09/113,057 |
| | | Method and | (Jul. 10, 1998) |
| | | Apparatus | |
| | | (ART51) | |
| PO7983 | 15 Jul. 1997 | Data Processing | 09/113,054 |
| | | Method and | (Jul. 10, 1998) |
| | | Apparatus | |
| | | (ART52) | |
| PO8026 | 15 Jul. 1997 | Image Processing | 09/112,752 |
| | | Method and | (Jul. 10, 1998) |
| | | Apparatus | |
| | | (ART53) | |
| PO8027 | 15 Jul. 1997 | Image Processing | 09/112,759 |
| | | Method and | (Jul. 10, 1998) |
| | | Apparatus | |
| | | (ART54) | |
| PO8028 | 15 Jul. 1997 | Image Processing | 09/112,757 |
| | | Method and | (Jul. 10, 1998) |
| | | Apparatus | |
| | | (ART56) | |
| PO9394 | 23 Sep. 1997 | Image Processing | 6,357,135 |
| | | Method and | (Jul. 10, 1998) |
| | | Apparatus | |
| | | (ART57) | |
| PO9396 | 23 Sep. 1997 | Data Processing | 09/113,107 |
| | | Method and | (Jul. 10, 1998) |
| | | Apparatus | |
| | | (ART58) | |
| PO9397 | 23 Sep. 1997 | Data Processing | 6,271,931 |
| | | Method and | (Jul. 10, 1998) |
| | | Apparatus | |
| | | (ART59) | |
| PO9398 | 23 Sep. 1997 | Data Processing | 6,353,772 |
| | | Method and | (Jul. 10, 1998) |
| | | Apparatus | |
| | | (ART60) | |
| PO9399 | 23 Sep. 1997 | Data Processing | 6,106,147 |
| | | Method and | (Jul. 10, 1998) |
| | | Apparatus | |
| | | (ART61) | |
| PO9400 | 23 Sep. 1997 | Data Processing | 09/112,790 |
| | | Method and | (Jul. 10, 1998) |
| | | Apparatus | |
| | | (ART62) | |
| PO9401 | 23 Sep. 1997 | Data Processing | 6,304,291 |
| | | Method and | (Jul. 10, 1998) |
| | | Apparatus | |
| | | (ART63) | |
| PO9402 | 23 Sep. 1997 | Data Processing | 09/112,788 |
| | | Method and Apparatus | (Jul. 10, 1998) |
| | | (ART64) | |
| PO9403 | 23 Sep. 1997 | Data Processing | 6,305,770 |
| | | Method and | (Jul. 10, 1998) |
| | | Apparatus | |
| | | (ART65) | |
| PO9405 | 23 Sep. 1997 | Data Processing | 6,289,262 |
| | | Method and | (Jul. 10, 1998) |
| | | Apparatus | |
| | | (ART66) | |
| PP0959 | 16 Dec. 1997 | A Data Processing | 6,315,200 |
| | | Method and | (Jul. 10, 1998) |
| | | Apparatus | |
| | | (ART68) | |
| PP1397 | 19 Jan. 1998 | A Media Device | 6,217,165 |
| | | (ART69) | (Jul. 10, 1998) |

We claim:

1. A method of processing a sensed image taken with a digital camera, including an auto exposure setting means, said method comprising the step of utilising the auto exposure setting from said auto exposure setting means to process said sensed image to add exposure specific graphics to said image.
